(19) United States
(12) Patent Application Publication
(10) Pub. No.: US 2007/0282874 A1
(43) Pub. Date: Dec. 6, 2007

(54) Content System

(75) Inventor: Luke Metcalfe, Woolwich (AU)

Correspondence Address: STEPTOE & JOHNSON LLP, 1330 CONNECTICUT AVENUE, N.W., WASHINGTON, DC, 20036, US

(73) Assignee: Rapid Intelligence PTY Ltd., Sydney (AU)

(21) Appl. No.: 10/568,285

(22) PCT Filed: Aug. 17, 2004
(86) PCT No.: PCT/AU04/01099

§ 371 Date: Mar. 29, 2007

(30) Foreign Application Priority Data
Aug. 19, 2003 (AU) 2003904446
Sep. 2, 2003 (AU) 2003904784

(51) Int. Cl. G06F 7/00

(52) U.S. Cl. 707/101; 707/E17.005

(57) ABSTRACT

A method of controlling the presentation of content instances using a processing system. The method involves causing the processing system to present one or more content instances to the user in accordance with a content network. The processing system then determines one or more responses provided by the user in response to the presentation of the content instance, before using the responses to evaluate the content in accordance with predetermined criteria. Following the evaluation the processing system modifies the content network to thereby vary the content presented in future.

### BACKGROUND OF THE INVENTION

The present invention relates to a method and apparatus for controlling the presentation of content using a processing system, and in particular, to controlling the presentation of content in accordance with a content network, or so as to modify the presented content to thereby increase its user appeal.

### DESCRIPTION OF THE PRIOR ART

The reference to any prior art in this specification is not, and should not be taken as, an acknowledgment or any form of suggestion that the prior art forms part of the common general knowledge.

Many methodologies exist for finding relationships between particular items of content, including relationships such as “people who liked/viewed/bought this, also liked/viewed/bought these” type of relationships as provided for example on Amazon.com. Accordingly, relationships of this form allow users to view other content that has been determined as similar to the content currently being viewed.

Currently, relationships such as these are derived using various kinds of statistical analysis of data collected from traffic logs, submitted user recommendations or purchasing information. In particular, this is often achieved by mapping an individual piece of content to another piece of content. This is generally achieved using a data mining technique known as association rules. As each piece of content is considered independently, there is typically a limit to the usefulness of the relationships.

In particular, this technique doesn't determine the links in accordance with a set of objectives that have been defined for the system, and doesn't examine paths followed by the users, but rather simply creates individual links on a case-by-case basis.

Other personalisation technologies are concerned with mapping content to known or implied user attributes. For example, a user might specify to a women's site that she has had a baby in the past 6 months and is from a high income group. The web site may respond by providing newsletter content on upmarket baby foods. While user profile based methodologies may be “added on” to this system, they are not required and indeed, the example implementation makes no use of it.

However, the ability of systems of this form to modify relationships without external user intervention is currently limited. In particular, such system usually require user intervention to configure the system for specific content, and monitor operation of the system to ensure that desired objectives are being met.

Also, the theory of memes draws an analogy between the spread of genetic information from generation to generation in the natural world, with the spread of ideas from person to person. When humans repeat ideas they have heard, they do not pass them on exactly how they heard them, with the effect that ideas are replicated imperfectly. As a result desirable elements of ideas which are added will tend to propagate in subsequent generations through the mechanism of natural selection. Thus, in a manner similar to the mechanism whereby differences between individuals in any given population impacting on the individuals survival chances, so to attributes of ideas can effect the survivability and reproducibility of the ideas.

The Internet provides a physical medium for the transmission of ideas and has consequently allowed for the proliferation of messages sent from user to user, such as chain letters and jokes. Messages of this form are generally sent from person to person when the sender considers the associated content worthwhile or appealing. In some cases, the recipient will change the content of the message, which may lead to an increase in the appeal of the content. A common example of this is a collection of amusing pictures sent embedded in an email. From time to time, users will omit or add other pictures so that this will result in the altered messages being passed on to others, and may even increase the likelihood of the message spreading when compared to the original “parent” message. Over time altered “descendant” messages can bear less and less resemblance to their ancestor.

In reality, most Internet users generally do not have a creative urge to actively change content. They are active only in selecting what content they view and subsequently pass on to others, thereby making there input to the dissemination of content substantially passive. As a result, with most users being passive, content is rarely modified and can be disseminated among millions of people without alteration. This is despite the fact that the people viewing the message may have differing tastes and backgrounds, meaning that the content is found unappealing to many individuals, such that they will tend not to pass the message on further.

A “Darwinian Poetry” website exists at http://www.codeasart.com/poetry/darwin.html which asks users to manually compare two computer-generated poems. Elements of poems which are often chosen survive while others die. However, in this system, the user views multiple competing content options to be displayed, and then selects those which are preferred. By contrast, the current content options are selected on the basis of competition between content options based on relative levels of traffic.

### SUMMARY OF THE PRESENT INVENTION

In a first broad form the present invention provides a method of controlling the presentation of content, the method including, in a processing system:
(a) Presenting content to a user in accordance with a content definition; and,
(b) Causing the content definition to be modified to thereby selectively modify content to be presented.

In a second broad form the present invention provides a system for controlling the presentation of content, the system including a processing system for:
(a) Presenting content to a user in accordance with a content definition; and,
(b) Selectively modifying the content definition to thereby selectively modify content to be presented.

Typically the content definition is modified by the processing system.

Typically the content definition includes at least one of:
(a) A content network; and,
(b) A content indication.

Typically the method includes:
(a) Determining if a respective modification results in the respective content being more successful at meeting predefined objectives; and,
(b) Increasing the frequency of presentation of the respective content in response to a successful determination.

Typically the content definition includes a content network having a number of nodes interconnected via a number of links, the links being used to define the content to be presented, and wherein the method includes modifying the content definition by modifying weightings associated with one or more of the links. Typically the content definition includes a content indication having a number of parameters used to define the content to be presented, wherein the method includes modifying the content definition by modifying the parameters.

Typically the method includes modifying the parameters in accordance with weightings, the weightings being indicative of the ability of content defined by the parameters to meet predetermined objectives.

Typically the method includes presenting content in accordance with input commands from the user.

Typically the commands include an indication of the selection of content to be presented.

Typically the method includes modifying the content definition at least one of:
(a) Randomly;
(b) In accordance with user responses; and,
(c) So as to increase the likelihood of the presented content meeting predefined objectives.

Typically the method includes iteratively modifying the content presented over time.

Typically the system performs the method of any one of the claims 1 to 11.

In a third broad form the present invention provides a method of controlling the presentation of content instances using a processing system, the method including causing the processing system to:
(a) Present one or more content instances to the user in accordance with a content network;
(b) Determine one or more responses provided by the user in response to the presentation of the content instance;
(c) Evaluate the one or more responses in accordance with predetermined criteria; and,
(d) Modify the content network in accordance with the results of the evaluation.

In a fourth broad form the present invention provides apparatus for controlling the presentation of content instances, the apparatus including a processing system adapted to:
(a) Present one or more content instances to the user in accordance with a content network,
(b) Determine one or more responses provided by the user;
(c) Evaluate the one or more responses in accordance with predetermined criteria; and,
(d) Modify the content network in accordance with the results of the evaluation.

The predetermined criteria can represent predefined objectives, the method including causing the processing system to evaluate the responses to thereby determine the ability of the one or more presented content instances to satisfy predefined objectives.

The method may include repeatedly modifying the content network such that content instances that are determined to be more able to satisfy the predetermined objectives are presented.

The method may include modifying the content network iteratively to thereby optimise the content network such that the ability of the content network to satisfy the predetermined objectives is improved.

The content network can include:
(a) An indication of a number of presentation instances, each presentation instance being associated with one or more content instances, and each content instance being associated with one or more presentation instances;
(b) One or more links for connecting each presentation instance to a subsequent presentation instance; and,
(c) A weighting associated with each link.

The method may include causing the processing system to modify the content network by modifying the weightings in accordance with the responses.

The method may include repeatedly modifying the weightings in accordance with determined responses to thereby modify the weightings of links according to how well they satisfy the predetermined objectives.

The method may include causing the processing system to present the content instances by:
(a) Presenting one or more of the content instances associated with a respective presentation instance;
(b) Selecting a link in accordance with the one or more responses, the link connecting the respective presentation instance to a subsequent presentation instance;
(c) Presenting the one or more content instances associated with the subsequent presentation instance; and,
(d) Repeating steps (b) and (c) as required.

If at least one of the responses including a request, the method typically includes causing the processing system to select a link in accordance with the request.

Each presentation instance can include one or more request options, each request option having one or more links associated therewith, the method including causing the processing system to:
(a) Determine the request from the one or more responses;
(b) Select a request option corresponding to the request; and,
(c) Select one of the links associated with the selected request option.

The method may include causing the processing system to modify the weightings of selected links by:
(a) Determining the one or more responses to the presentation of the one or more content instances associated with a respective presentation instance; and,
(b) Modifying the weighting of each link selected prior to the content instances being presented in accordance with the determined response.

The method may include causing the processing system to modify the content network by modifying the links, the modifications including at least one of:
(a) Removing a respective link;
(b) Creating a new link; and,
(c) Moving a link from one presentation instance to another presentation instance.

The method may include causing the processing system to compare one or more of the weightings to a predetermined threshold and perform the modification in accordance with the results of the comparison.

The predetermined threshold can be determined in accordance with the weighting of other links in the content network.

The method may include causing the processing system to create a new link if at least one of:
(a) The weighting of one or more existing links falls below a lower threshold;
(b) A rating of one or more content instances or presentation instances falls below a lower threshold; and,
(c) The weighting of one or more existing links is above an upper threshold; and,
(d) A rating of one or more content instances or presentation instance is above an upper threshold.

The method may include causing the processing system to remove a link if at least one of:
(a) The weighting of the link falls below a lower threshold; and,
(b) One of the presentation instances to which the link is associated is removed.

The method may include causing the processing system to update the content network by:
(a) Determining one or more new presentation instances; and,
(b) Create one or more links associated with each new presentation instance, the links linking each new presentation instance to one or more existing or other new presentation instances.

The method may include determining the new presentation instances in accordance with ratings associated with each content instance or each presentation instance.

The method may include causing the processing system to:
(a) Determine the one or more content instances associated with a respective presentation instance;
(b) Select one or more of the content instances; and,
(c) Present the one or more selected content instances.

The method may include causing the processing system to:
(a) Determine a weighting for each content instance associated with the presentation instance; and,
(b) Select the one or more content instances associated with the presentation instance in accordance with the determined weighting.

Each presentation instance can have one or more content instance criteria associated therewith, the method including causing the processing system to:
(a) Determine the one or more content instance criteria; and,
(b) Select one or more content instances in accordance with the content instance criteria.

One or more of the content instances, the presentation instances or the links can include predetermined instructions, the method including causing the processing system to:
(a) Determine the instructions; and,
(b) Present one or more content instances in accordance with the instructions.

The instructions may include references to one or more content instances, the method including causing the processing system to:
(a) Select the one or more content instances in accordance with the instructions; and,
(b) Present the one or more content instances.

The method may include selecting the one or more content instances in accordance with at least one of:
(a) A content instance rating;
(b) A content instance weighting;
(c) A content instance type, each content instance having an associated type determined in accordance with the nature of content contained therein; and,
(d) Descriptive data (structured or unstructured) pertaining to the content instance's relationship to other content instances.

Each content instance, presentation instance, link or content instance combination can have an associated rating, the method including causing the processing system to:
(a) Evaluate each response in accordance with the predetermined criteria;
(b) Determine a rating modification in accordance with the results of the evaluation; and,
(c) Apply the rating modification to the corresponding content instance, presentation instance, link or content instance combination upon which the response is based.

The predetermined criteria may include one or more criteria instances, each criteria instance including an indication of a respective rating modification, the method including causing the processing system to:
(a) Evaluate each response in accordance with one or more selected criteria instances; and,
(b) Determine the associated rating modification in accordance with the results of the evaluation.

The content instances can be stored in a store, the method including causing the processing system to:
(a) Receiving new content instances;
(b) Storing the new content instances in the store; and,
(c) Amending the content network in accordance with the new content instances.

The method may include causing the processing system to determine from the response at least one of:
(a) A rating provided in response to the presentation of the content instance, the rating being provided by the user;
(b) An indication of the length of time the user spent observing the content instance; and,
(c) An indication of whether the presentation of the content instance to the user caused a predetermined event.

The one or more of the responses can include a request, the method including causing the processing system to present further content instances in accordance with the determined requests.

The processing system can be coupled to an end station via a communications network, the method including causing the processing system to:
(a) Transfer content instance to be presented to the end station via the communications network the end station being adapted to present the content instance to the user; and,
(b) Receive a response generated by the end station via the communications network.

In a fifth broad form the present invention provides a method of controlling the presentation of content to a user using a processing system, the method including causing the processing system to:
(a) Receive a content indication representing content to be displayed;
(b) Present the content in accordance with the content indication; and,
(c) Selectively distributing the content indication to at least one of: ***
   (i) Other processing systems; and,
   (ii) Other users; and,
(d) Selectively modify the content indication prior to at least one of:
   (i) Presenting the content; and,
   (ii) Distributing the content.

In a sixth broad form the present invention provides apparatus for controlling the presentation of content to a user, the apparatus including a processing system adapted to:
(a) Receive a content indication representing content to be displayed;
(b) Present the content in accordance with the content indication; and,
(c) Selectively distributing the content indication to at least one of:
   (i) Other processing systems; and,
   (ii) Other users; and,
(d) Selectively modify the content indication prior to at least one of:
   (i) Presenting the content; and,
   (ii) Distributing the content.

The content indication can be the content, the method including selectively modifying the content indication by modifying the content.

The content indication can be a content specification defining the content to be presented, the method including selectively modifying the content indication by modifying the content specification to thereby modify the content presented.

The content specification can include a number of parameters defining the content to be presented, the method including:
(a) Modifying the content specification by modifying the parameters; and,
(b) Presenting the content in accordance with the parameters.

The content specification can include a computer program, the method including causing the processing system to execute the computer program to thereby allow the content to be presented.

The content specification can be a URL, the method including causing the processing system to present the content as a web page.

The content can be a content collection, the content collection including one or more content instances.

The content instances can include at least one of:
(a) Images;
(b) Textual information;
(c) Audio information;
(d) Executable code;
(e) Display code;
(f) Data objects;
(g) Links to other content; and,
(h) Multimedia objects.

The method may include causing the processing system to present the content instances in accordance with a template, the template being determined in accordance with the content indication.

The processing system can be coupled to a store for storing a number of content instances, the method including:
(a) Obtaining one or more content instances from the store; and,
(b) Presenting the content including the obtained content instances.

Typically the method includes at least one of:
(a) Selecting one or more of the number of content instances in accordance with the parameters; and,
(b) Modifying one or more of the content instances in accordance with the parameters.

The content being in the form of a web-page, the content indication being a URL, the method including causing the processing system to:
(a) Modify the URL; and,
(b) Using a re-direct process to present a web-page in accordance with modified URL.

The method of modifying the content indication can include:
(a) Transferring the content indication to the processing system using a form; and
(b) Causing the processing system to:
(c) Receive the form;
(d) Modify the content indication; and,
(e) Distribute the modified content indication.

The method may include selectively modifying the content indication in accordance with predetermined mutation rules.

The mutation rules can define at least one of:
(a) Whether the content indication is to be modified; and,
(b) The nature of any modification to be performed.

The method may include causing the processing system to determine the mutation rules from at least one of:
(a) A store coupled to the processing system; and,
(b) The content indication.

The mutation rules may include modifying the parameters:
(a) Randomly;
(b) By selecting alternative parameters from a predetermined list;
(c) In accordance with input commands received from a user; and,
(d) By modifying the parameters in accordance with predetermined rules.

The method may include causing the processing system to:
(a) Maintain a log, the log indicating previous presentations of the respective content; and,
(b) Modify the content indication in accordance with the respective log.

The method may include causing the processing system to maintain the log in the content specification.

The processing system can include a base station coupled to one or more end stations via a communications network, the method including:
(a) Causing the end station to;
   (i) Receive the content indication from another end station; and,
   (ii) Transfer at least a portion of the content indication;
(b) Causing the base station to:
   (i) Receive the content indication portion from the end station;
   (ii) Determine the content for presentation in accordance with the content indication portion;
   (iii) Transfer the selected content to the end station via the communications network; and,
(c) Causing the end station to display the selected content.

The method may include causing the base station to modify the content indication portion.

The content indication can be a content specification, and the content indication portion being parameters included in the content specification.

The method may include causing the processing system to:
(a) Receive new content from user;
(b) Modify content indications to thereby cause the new content to be presented.

The method may include:
(a) Causing the end station to:
   (i) Receive the new content from the user; and,
   (ii) Forward the new content to the base station; and,
(b) Causing the base station to:
   (i) Receive the new content;
   (ii) Store the new content in a store; and,
   (iii) Modify one or more content indications to thereby cause the new content to be displayed.

The method may include causing the processing system to:
(a) Receive input commands from a user; and,
(b) Define a user defined content indication in accordance with input commands, the user defined content indication being adapted to cause content selected by the user to be presented.

The method may include causing the processing system to:
(a) Provide an indication of available content;
(b) Allow the user to select available content in accordance with the available content indication; and,
(c) Generate a user defined content indication in accordance with the selected content, the user defined content indication being adapted to cause the selected content to be displayed.

The method may include causing the processing system to:
(a) Monitor the distribution of user defined content indications; and,
(b) Provide an indication of the distribution to one or more users.

The method may include causing the processing system to:
(a) Comparing the distribution of a number of user defined content indications or user-submitted content instances;
(b) Assess the relative success of the user defined content indications in accordance with the results of the comparison; and,
(c) Providing an indication of the relative success to one or more users.

The method may include distributing the content in accordance with input commands received from the user.

The content may include web pages, the web pages having one or more links to other web pages.

The method may include modifying the content by modifying the links.

The method may include:
(a) Monitoring the number of times each web page is viewed; and,
(b) Modifying the links in accordance with the relative number of times each page is viewed.

### BRIEF DESCRIPTION OF THE DRAWINGS

An example of the present invention will now be described with reference to the accompanying drawings, in which:—

FIG. 1 is a schematic diagram of an example of a processing system;

FIG. 2 is a flow chart of an example of a process for controlling the presentation of content;

FIG. 3 is a schematic diagram of an example of a content network utilised by the processing system of FIG. 1;

FIG. 4 is a schematic diagram of an example of a distributed network system;

FIG. 5 is a schematic diagram of an example of an end station of FIG. 4;

FIGS. 6A and 6B are a flow chart detailing an example of the process of controlling the presentation of content using the system of FIG. 4;

FIGS. 7A to 7 E are a flow chart detailing an example of the process of modifying the content network using the system of FIG. 4;

FIG. 8 is a flow chart of an example of a process of modifying content for presentation to users;

FIG. 9 is a flow chart detailing a first example of the process of FIG. 8; and,

FIG. 10 is a flow chart detailing a second example of the process of FIG. 8.

### DETAILED DESCRIPTION OF THE PREFERRED EMBODIMENTS

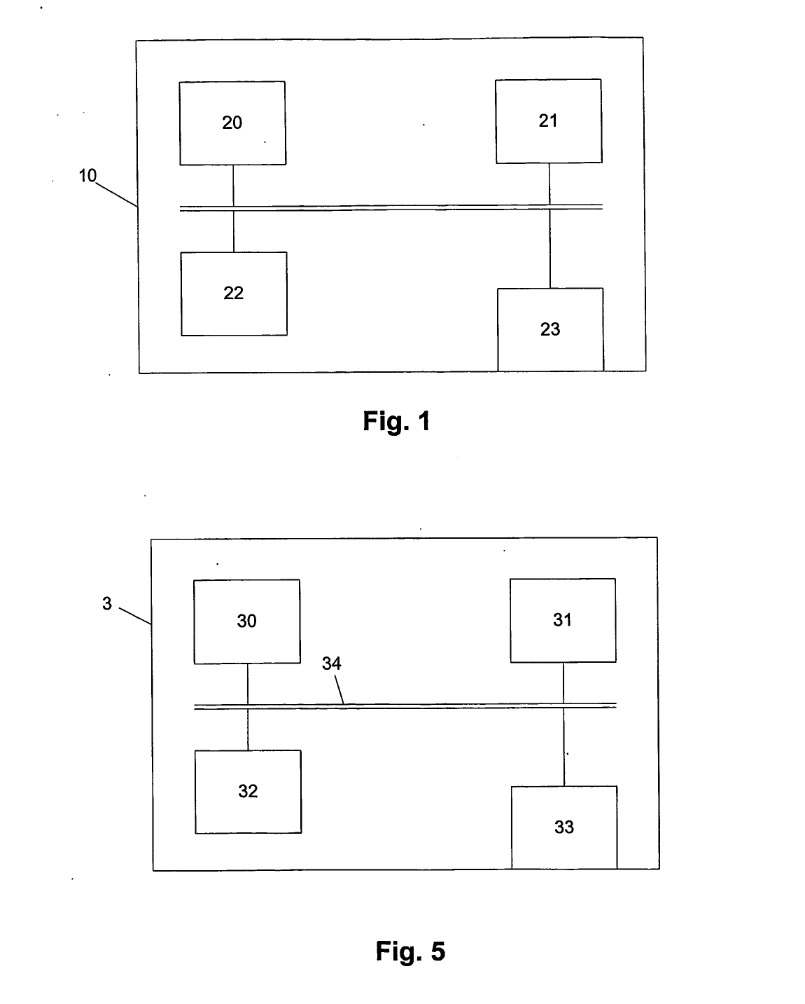

An example of apparatus suitable for presenting content to a user in accordance with the present invention will now be described with reference to FIG. 1.

In particular, as shown the apparatus is formed from a processing system 10 coupled to a data store, such as a database 11, or the like. In use content instances, such as images, text, and multimedia content, are stored in the database 11. Accordingly, the database is typically a relational database, or the like, although any suitable form of data store may be used.

In one example, the processing system 10 is adapted to present content instances to a user. The processing system then rates a user's response and uses this to modify the manner in which the content instances are presented in future. In another example, the processing system 10 modifies content presented to user, to thereby provide the user with alternative content. The aim of this is to attempt to improve the appeal or level of interest in the content, by increasing the likelihood of the content being distributed to other individuals. By making repeated adjustments to the content in accordance with predetermined rules, this aims to maximise the popularity of the content, by improving the ability of the information to propagate between users.

It will be appreciated that this may be achieved by any form of processing system. However, in one example the processing system includes a processor 20, a memory 21, an input/output (I/O) device 22, such as a monitor and keyboard or the like, and an external interface 23 coupled together via a bus 24. In use, the external interface 23 allows the processing system to be coupled to other processing systems, via a communications network or the like, as will be described in more detail below.

Accordingly, it will be appreciated that the processing system may be any form of processing system suitably programmed to perform the presentation and/or modification of content, as will be described in more detail below. The processing system may therefore be a suitably programmed computer, lap-top, palm computer, PDA, server, suitable programmed mobile phone, interactive television, or the like. Alternatively, specialised hardware or the like may be used.

Content Presentation

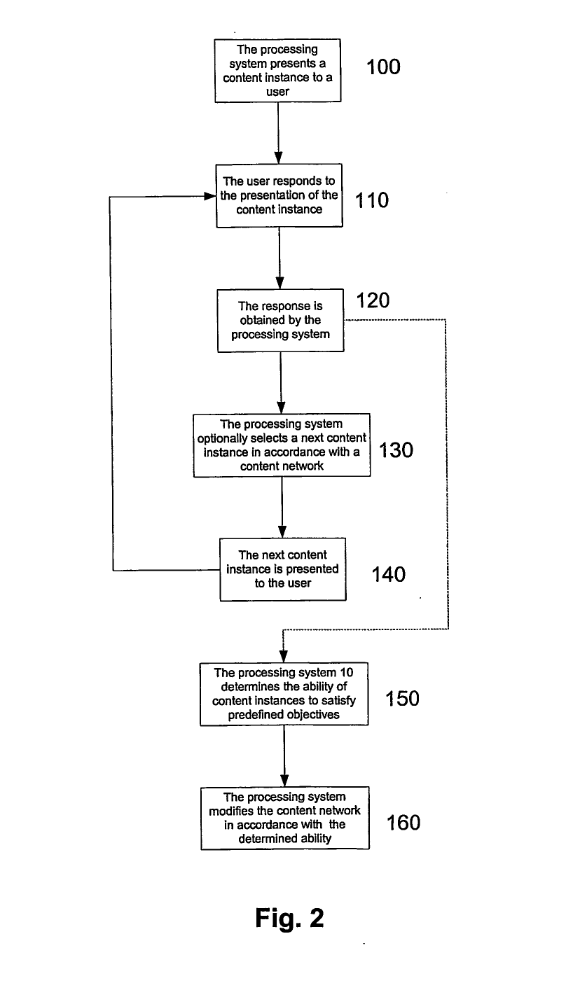

An overview of one example for presenting content will now be outlined with reference to the flow chart of FIG. 2.

In particular, at step 100, a respective content instance is displayed to the user. This may be achieved by having the user select a content instance from a list, or the like. Alternatively the content instance may be selected automatically by the processing system, or the like. This will depend on the respective implementation. Thus, for example, if the content instances are images, the user may be presented with a number of thumbnail images, allowing a respective content instance (image) to be selected. Alternatively, the content instances may be web pages, in which case, the first content instance may a home page on a web site, or the like.

At step 110, the user responds to the presentation of the content instance. The manner in which the response is made will depend on a number of factors, and will be discussed in more detail below. However, the response may for example be a rating relating to the user's appreciation of the content instance, an indication of the length of time the content instance is viewed for, the purchase of an item in response to an advert, or the like.

At step 120, the response is obtained by the processing system. The response may be used by the processing system to select a next content instance at step 130. The next content instance is selected using a content network, which sets out for each content instance, one or more links to other available content instances. The processing system presents the next content instances in accordance with the links and any request for further content which is determined from the responses provided by the user.

The next content instance is then displayed to the user at step 140, allowing the user to again provide responses at step 110. The steps 110 to 140 may then be repeated a number of times, allowing the user to view a number of different content instances associated with each other via respective ones of the links. The viewed content instances then form a particular sequence of content instances.

At step 150, the processing system uses the one or more of the responses and predetermined criteria to assess the ability of one or more of the content instances in the sequence to satisfy predefined objectives.

At step 160, the processing system then modifies the content network in accordance with the determined ability, which in turn modifies the content instances that will be displayed in future. Repeating this process iteratively enables the content network to be optimised to allow content instance sequences that are more successful at satisfying the predetermined objectives to be presented in future. The modification of the content network may be achieved in a number of ways. However, in one example, this is achieved by assigning weightings to each of the links between respective content instances. The weightings are then modified depending on the success of the ability of the content instances to meet the objectives. The weightings are then used to control which content instances are presented in future, allowing the content instances that best satisfy the objectives to be used more often.

Thus, for example, each content instance may correspond to a web page on a web-site, with the desired objective being to keep users interested in the site, so that they browse the site for as long a time as possible. Accordingly, in this case, the responses are indications of the time which users spend on each web page in a particular sequence of web pages defined by the content network.

This effectively allows the processing system 10 to assess the ability of the particular web pages or web page sequences to retain the user's interest. The processing system then uses this information to modify weightings associated with respective web pages sequences, thereby modifying the web pages to be presented in future. Repeating this procedure allows the success of a range of different web page sequences to be evaluated, to allow the more successful content image sequences to be developed.

Thus, preferably the system is operated for a sufficient period of time to allow a statistically significant number of users follow at least some of the individual links (and preferably those links which are later updated). Each link is judged according to the ability of the subsequently presented content instances to satisfy the predefined objectives.

An example of the broad form of formula that may be used is:
Q=W/n (1)
Where
   Q is the quality of the link
      W is the total weightings for all desirable things performed by all users who followed the link, and
      n is the number of users who followed the link.

However, it will be appreciated that the modifications to the links weightings may be achieved in other ways, and in accordance with other formulas.

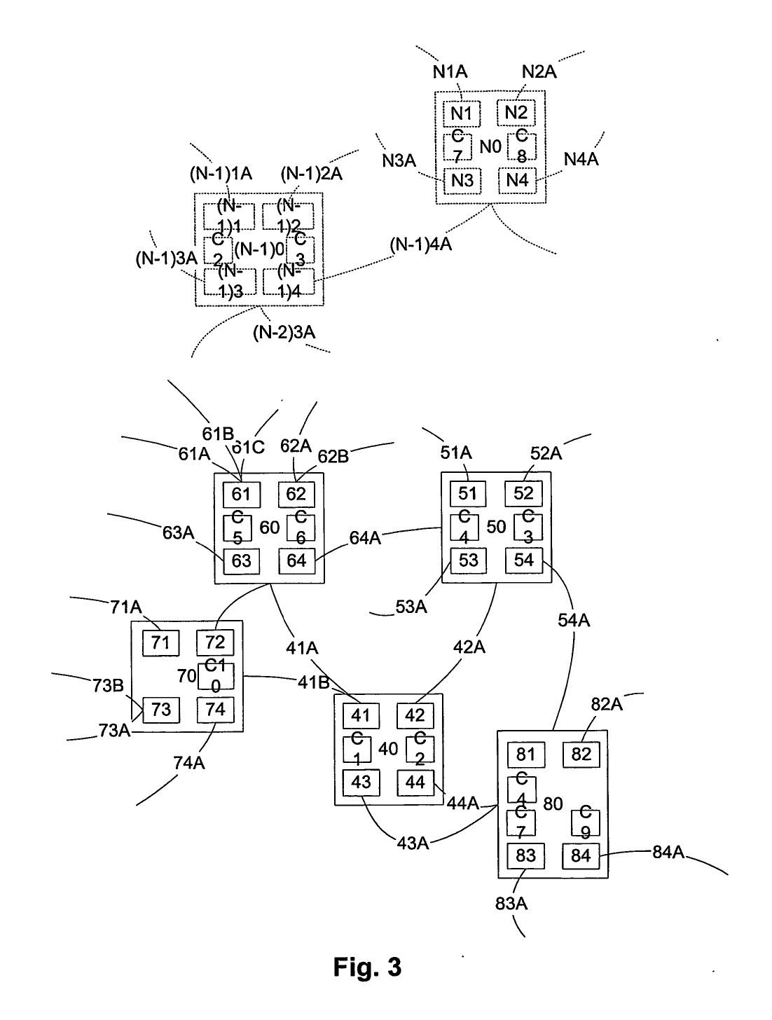

An example of a content network is shown in FIG. 3. As shown the content network includes a number of presentation instances 40, 50, 60, 70, 80, . . . , (N−1), N0. Each presentation instance is associated with one or more corresponding content instances C1, C2, . . . , C10, with each content instance C1, C2, . . . , C10, being associated with one or more different presentation instances 40, 50, 60, 70, 80, . . . , (N−1), N0.

It will be appreciated that in general each content network would include a large number of presentation instances, to allow each content instance to be represented one or more times within the network, possibly in combination with different content instances. However, only a small number have been shown in this example for clarity.

Each presentation instance 40 has a number of associated request options 41, 42, 43, 44 associated therewith. Each request option represents a possible request for further content from the user. Typically the request option will be determined from a response that the user may make following display of the respective content instance(s) C1, C2, . . . , C10. Associated with each request option are one or more respective links, 41A, 41B, 42A, 43A, 44A that link the presentation instance to subsequent presentation instances 50, 60, 70, 80, . . . , (N−1), N0, as shown.

This allows the processing system to determine the next content instance(s) C1, C2, . . . , C10, that may be displayed.

Thus, for example, when the processing system 10 presents the content instances C1, C2 associated with the presentation instance 40 to the user, the processing system will examine any response to determine if it includes a request for further content. If so, the processing system 10 determines to which of the request options 41, 42, 43, 44 the request corresponds. The processing system 10 selects a respective link based on the determined request option. Thus for example, if the user selects a response corresponding to the request option 41, the processing system 10 may select either one of the links 41A, 41B, allowing either one of the content instances 60, 70 to be presented to the user.

Each link has a respective weighting assigned thereto, as will be described in more detail below. In the event that a selected request option 41 has multiple links 41A, 41B associated therewith, the processing system may select one of the links 41A, 41B, and hence one of the content instances 70, 60 in accordance with the weighting. Thus for example, if the link 41A has a weighting “10”, whilst the link 41B has a weighting “20”, then the link 41B may be selected twice as often as the link 41A. However, alternatively, each link could be selected an equal number of times.

In general, the content network is maintained by storing data representing each of the presentation instances in the database 11. In particular, the database would typically include at least a content table storing details of each content instance, a presentation table storing details of each presentation instance, a link table for storing details of each link. The processing system 10 can then modify the content network by updating the tables in the database, as will be appreciated by those skilled in the art.

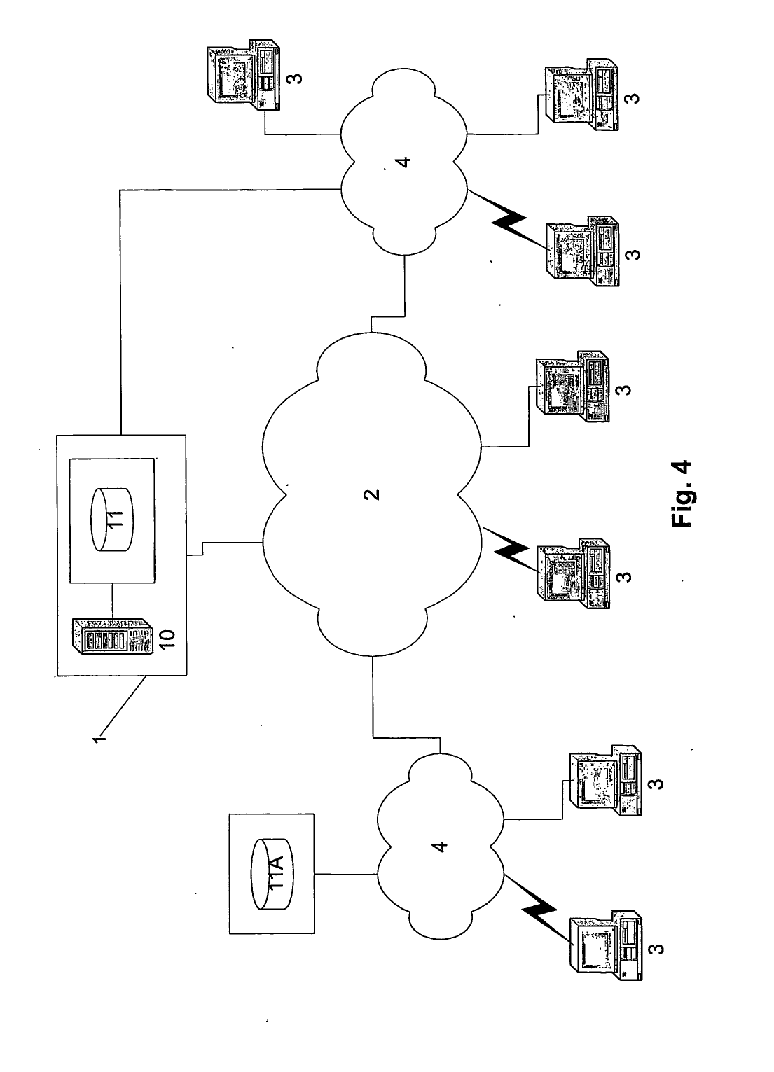

It will be appreciated that the above may be achieved using a distributed architecture formed from a processing system 10 coupled to a number of remote end stations 3 via a communications network. This can be used for example to present web pages containing images, or the like, to users of remote end stations. An example system is shown in FIG. 4.

As shown, the system includes a base station 1 coupled to a number of end stations 3, via communications network 2, such as the Internet, and one or more other communications networks 4, such as local area networks (LANs), or the like.

In this example, the base station 1 may be adapted to present content, or control the presentation of content, to users of the end stations 3. In order to achieve the base station 1 includes a processing system 10, similar to the processing system 10 described above with respect to FIG. 1, which is coupled to a data store, such as a database 11. Additional remote databases 11A may also be provided coupled to the Internet 2 or the communications or the LANs 4.

In one example, the base station 1 is generally adapted to store content for presentation to the users and may also be adapted to mutate the content. The content may be in any one of a number of forms, such as in the form of web pages, e-mails or the like. Accordingly, the base station 1 may be adapted to generate web pages and display these to users of the end stations 3 in accordance with a received content specification such as a URL, or to operate to transfer e-mail between users by acting as an e-mail exchange server, or to simply provide content in response to a request. In any event, the base station 1 and end stations 3 must generally be adapted to communicate to allow the content to be presented as required. It will be appreciated by persons skilled in the art that the base station 1 is not required, for example if the content is distributed through a peer-to-peer network and is included in this example for the purpose of illustration only.

An example of a typical end station 3 is shown in FIG. 4. As shown the end station 3 includes a processor 30 coupled to a memory 31, an I/O device 32, such as a monitor and keyboard, an e-port or the like, and an external interface 33, coupled together via a bus 34. In use the external interface 33 is adapted to allow the end station to connect to a suitable one of the communications networks 2, 4 and may therefore be an Ethernet LAN card, modem, or the like.

It will be appreciated from this that the processing system 10 provided in the base station 1 is typically in the form of a server, such as a web e-mail server, with the end station 3 being a suitably programmed computer, lap-top, palm computer, PDA, mobile phone, or the like, and which is typically adapted to enable content presentation such as by web-browsing or the like. Alternatively, however specialised hardware or the like may be used.

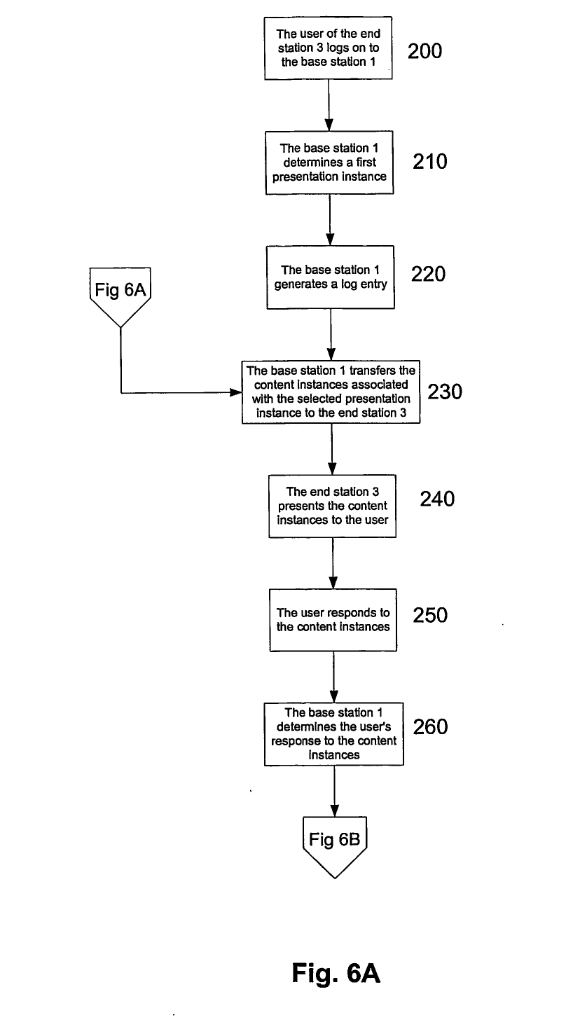

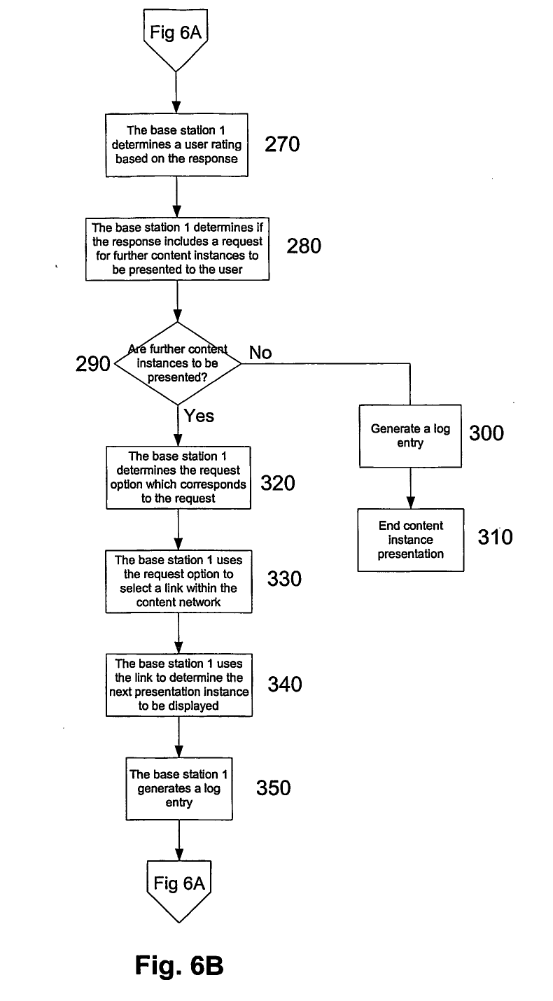

An example of the manner in which content instances in the form of web pages can be displayed to users of the end stations 3 will now be described with reference to FIGS. 6A and 6B.

In this example, as shown in FIG. 6A, the user of the end station 3 logs in to the base station 1 at step 200. In order to achieve this, the user will typically be provided with a username and password, copies of which are stored at the base station 1. This allows the username and password, and hence the identity of the user, to be subsequently verified. The manner in which login may be achieved will be appreciated by those skilled in the art and will not therefore be described in any further detail.

As a result of the login procedure, the base station 1 will determine a user ID representative of the identity of the user. The base station 1 will also generate a session ID representative of the respective session in which content instances are presented, as will be appreciated by a person skilled in the art.

It will be appreciated that users may not wish to perform registration procedures to provide information. Accordingly, user ID and session IDs may be determined through the use of cookies instead, thereby preventing the need for user names and passwords to be provided.

In any event, at step 210 the base station 1 determines a first presentation instance to present to the user. This may be for example a web page including one or more content instances thereon.

In any event, in this example, each web page is designed to be rated by the user on a scale of one to four. Thus, in this example, the user rating “one” corresponds to information that the user rates as “good”, whilst the user rating “four” corresponds to information which the user rates as “bad” with intervening ratings corresponding to “average” and “poor” respectively. In any event, it will be appreciated that the exact nature of the information is not essential to the present invention. Accordingly, the information may correspond to, images, video clips, music, text information, portions thereof, combinations thereof, or the like.

In any event, at step 220 the base station 1 generates a log entry. The log entry is used to record exactly what information was displayed to the user, together with an indication of any responses that may be received from the user. Accordingly, the log typically includes indications of:
Content ID(s) representative of the current instance(s) being displayed
A presentation ID representative of the presentation instance
A link ID representative of the link followed to reach this presentation instance
The user rating for the previously presented presentation instance
The user ID
The session ID

The log entry generated the first time the presentation instance is displayed, will not include a link ID or user rating. Accordingly, if the first presentation instance presented is the presentation instance 40, an example of the log entry for the presentation of the presentation instance 40, may be as shown in Table 1.

TABLE 1

| | Presentation | | | | |
|---|---|---|---|---|---|
| Content | instance(s) | Link | User | User | Session |
| ID | ID(s) | ID | Rating | ID | ID |
| 40 | C1, C2 | | | UID1 | SID1 |

At step 230 the base station 1 transfers the web page associated with the respective presentation instance to the end station 3 for presentation to the user. The web page including the content instances C1, C2, is presented to the user by the end station 3 at step 240. The user responds to the content instances, which in this example involves rating the content on a scale of “one” to “four”. In this example, the user rating will typically be selected by selecting an appropriate link such as a hyperlink on the web page.

An indication of the specified rating is transferred to the base station, to allow the base station 1 to determine the user's response and rating at step 260 and 270. In this case, the response is the rating. However, if alternative forms of responses are used, this may require that the processing system 10 interpret the response to determine a user rating therefrom, as will be described in more detail below.

It is also possible that the response will not include any form of rating but, instead is used simply to judge the user's behaviour, such as whether the relevant content instance was viewed by the user, and whether this led the user to view further content. However, this behaviour can be interpreted as a form of rating by the processing system 10, and it will therefore be appreciated that the general techniques described below can be applied even in the event that no explicit rating is provided by the user.

After determining the user rating at step 270, the base station 1 examines the response to determine if it includes a request for further content instances to be presented to the user at step 280. In particular, in this example, after rating the respective presentation instance, the user is presented with a further presentation instance, which is selected based on the rating given to the previous presentation instance. The request for further presentation instances to be presented may be inherent or explicit within the response.

If it is determined that no further content instances are to be presented at step 290 then the base station 1 generates a log entry at step 300, which includes the rating given to the presented presentation instance. The presentation procedure for this session then ends at step 310.

Otherwise the base station 1 operates to determine which request option corresponds to the request provided in the response at step 320.

Thus, in the above example, if the first presentation instance displayed to the user is the presentation instance 40, then the presentation instance includes four associated request options 41, 42, 43, 44, each of which corresponds to a different user rating “one”, “two”, “three”, “four”. Thus, if the user selects the rating “one”, then the processor determines that the request option 41 has been selected.

Accordingly, from this the base station 1 determines that it must select a respective one of the links 41A, 41B that are associated with the request option 41. The manner in which this achieved depends on the particular implementation.

Thus, for example, the base station may be adapted to ensure that the links are selected in accordance with the weightings, such that links with greater weightings are selected more frequently than links having lower weightings. Thus as briefly outlined above, if for example the FIG. 41A has a weighting “ten” whereas the link 41B has a rating “5” then the link 41A will be selected twice as often as the link 41B.

However, in this example, the processing system is adapted to ensure that the links 41A, 41B are selected with equal probability such that each link 41A, 41B is used a similar number of times as the number of times the respective request option 41 is selected increases. Accordingly, in this example, the weightings are not used to control which link is selected.

Once the processing system 10 has selected a link at step 330, the base station 1 uses the link to determine the next presentation instance to be presented to the user. Thus, for example, if the link 41A is selected the presentation instance 60 is then presented. At step 350 the base station 1 generates a log entry including an indication of the selected link. An example of the log including the new log entry is as shown in Table 2.

TABLE 2

| | Presentation | | | | |
|---|---|---|---|---|---|
| Content | instance(s) | Link | User | User | Session |
| ID | ID(s) | ID | Rating | ID | ID |
| 40 | C1, C2 | | | UID1 | SID1 |
| 60 | C5, C6 | 41A | “one” | UID1 | SID1 |

The processor then returns to step 230 and transfers the respective content instances to the end station 3. It will be appreciated that the procedure outlined in steps 230 to 350 is then repeated as required and in particular, as often as often as necessary in accordance with responses received from the user.

Accordingly, it will be appreciated that this continues for as long as content instances associated with the selected presentation instances are displayed to the user.

Thus, for example, the log would be extended, as shown for example in Table 3.

TABLE 3

| | Presentation | | | | |
|---|---|---|---|---|---|
| Content | instance(s) | Link | User | User | Session |
| ID | ID(s) | ID | Rating | ID | ID |
| 40 | C1, C2 | | | UID1 | SID1 |
| 60 | C5, C6 | 41A | “one” | UID1 | SID1 |
| . . . | . . . | . . . | . . . | . . . | . . . |
| N-1 | C2, C3 | (N-2)3A | “Three” | UID1 | SID1 |
| N | C7, C8 | (N-1)4B | “Four” | UID1 | SID1 |

Periodically, the base station 1 will operate to update the content network by analysing the log entries generated during the process described above with respect to FIGS. 6A and 6B. This may be achieved in a number of different ways depending on the respective implementation. Thus, for example, the base station 1 may process each log entry as it is created, updating the content network as each response is provided.

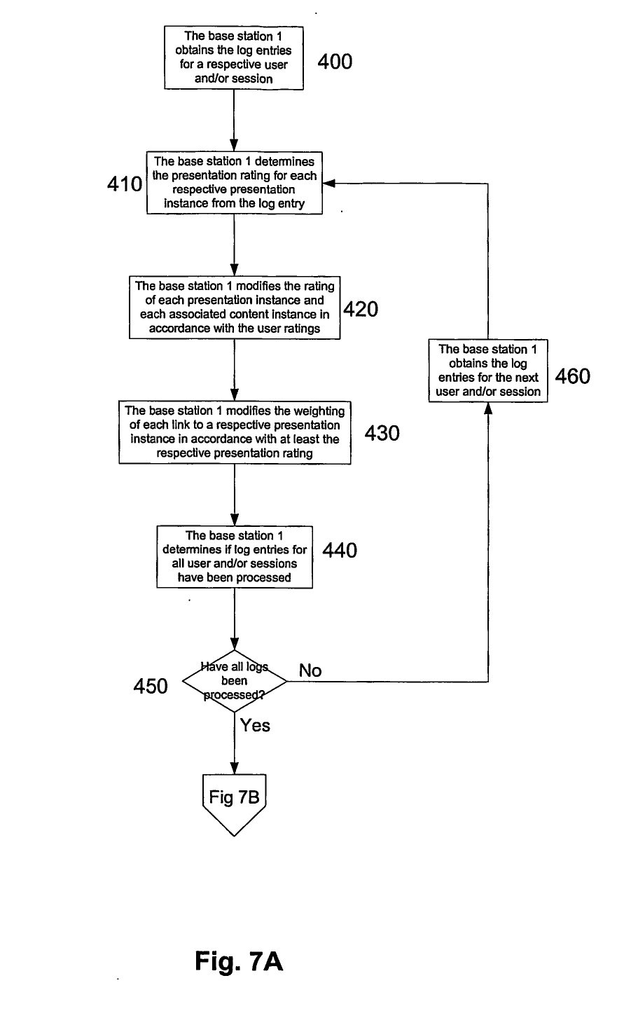

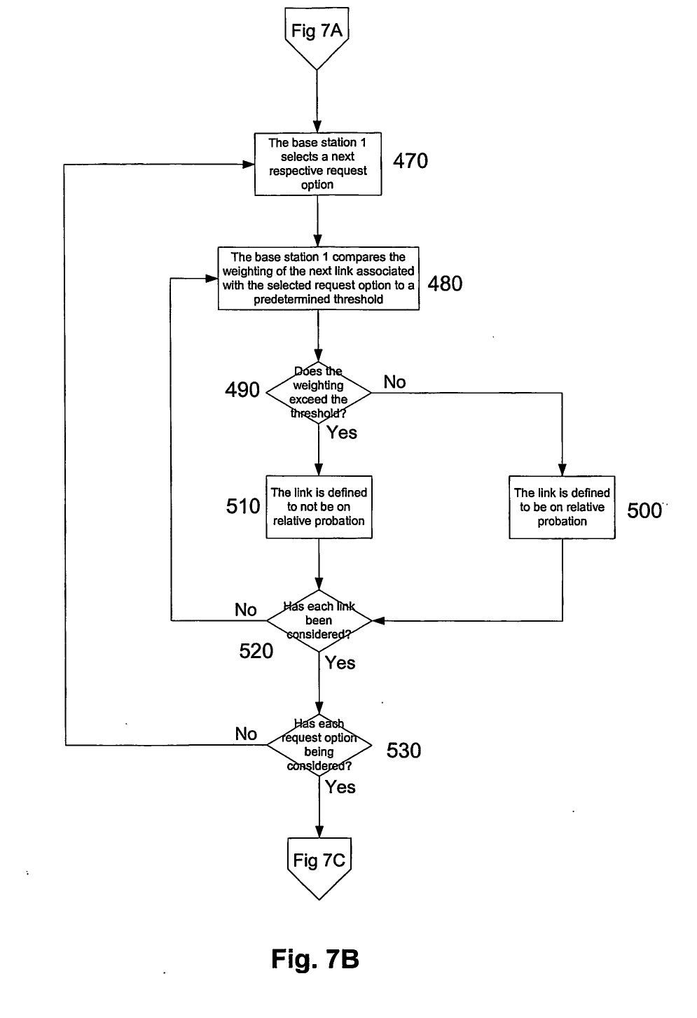

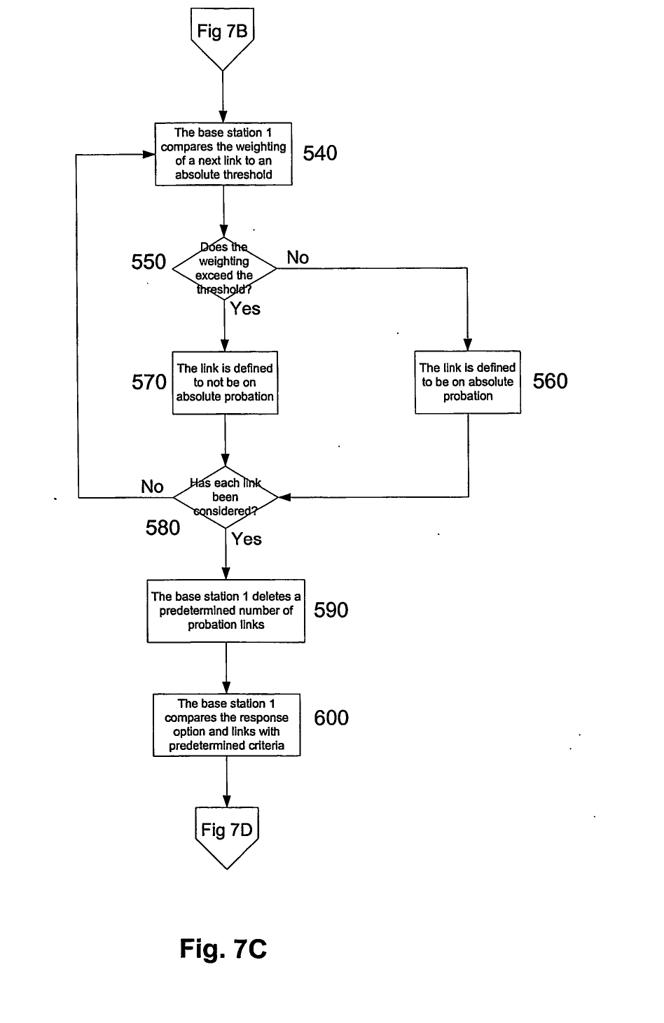

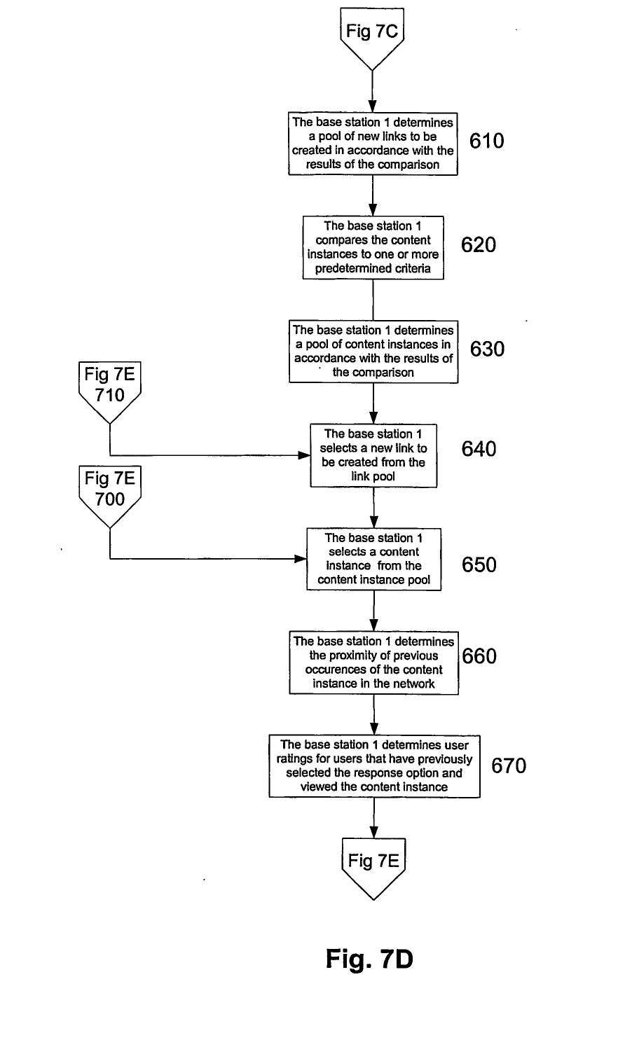

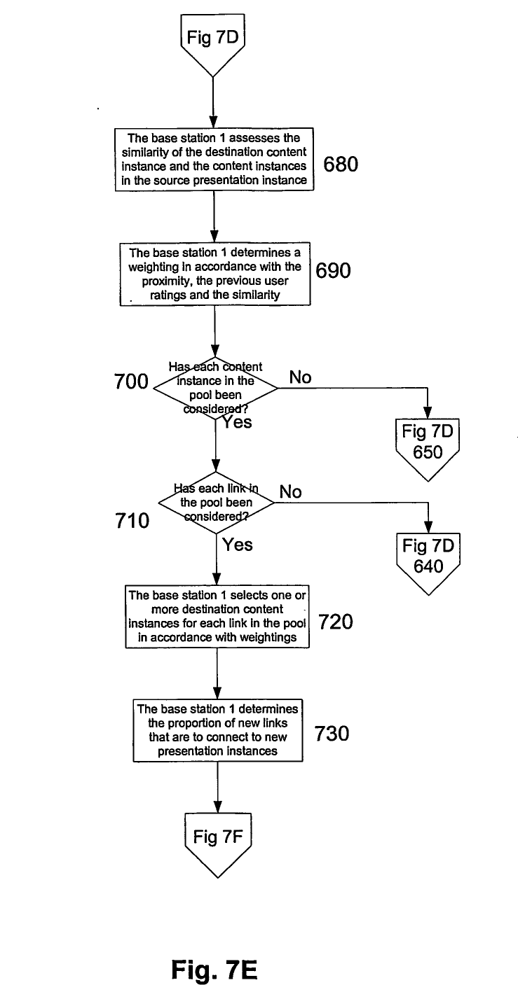

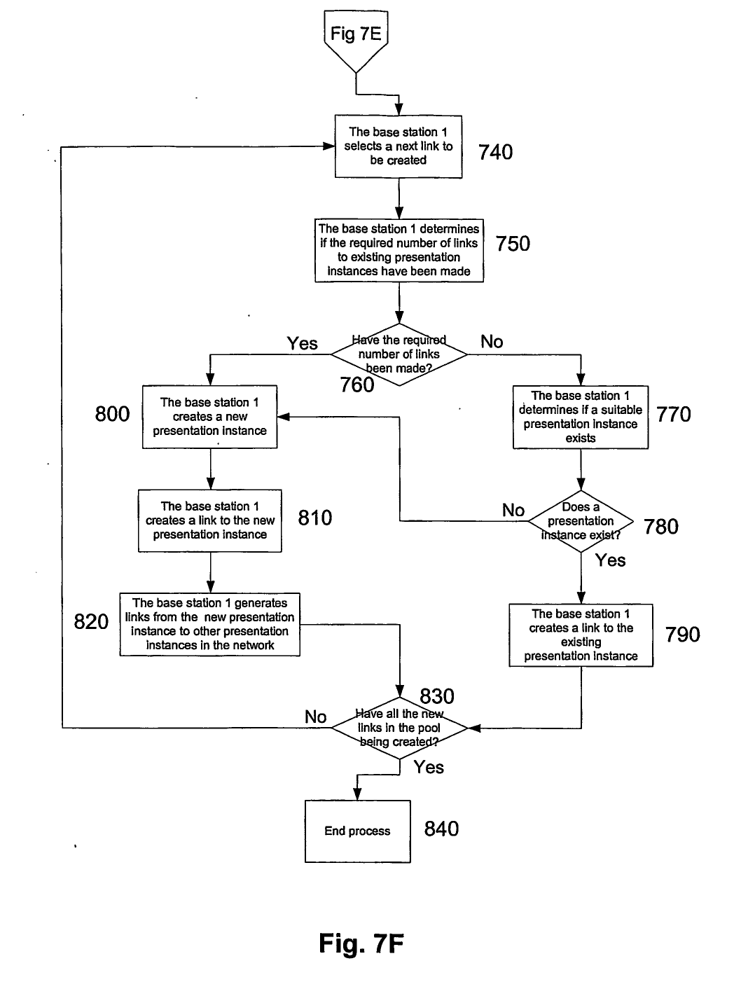

However, in this example, which will now be described with reference to FIGS. 7A to 7E, the base station 1 waits until a predetermined number of logs are created or until a predetermined amount of time has passed since the last processing. This is preferably performed to allow a statistically significant number of users to traverse at least some of the links in the network. More specifically, it is preferably that only links that have been traversed a statistically significant number of times are updated, to prevent spurious results unduly effecting the network layout.

Thus for example, if a link is updated after only a single user has traversed the link the updated link will only reflect the ratings provided by that user, and not the effect of a number of users, whom may all rate the associated content instances differently. Similarly, it is preferable that new links are only created for request options that have been selected a statistically significant number of times, for similar reasons.

As shown in FIG. 7A, the process may be achieved by having the base station 1 obtain the log entries for a respective user and/or session at step 400. This will be achieved using the user and session IDs stored in the log entry as will be appreciated by those skilled in the art. At step 410 the base station 1 determines the user rating for each presentation instance from the log entries. The base station uses this to modify the weighting of each link selected during the presentation of the content instances to the user during the respective session.

At step 420, the base station 1 then modifies the weighting of each link selected in accordance with the user rating assigned to one more of the presentation instances after the link. Thus, the weighting of the link is modified to represent the success of the presentation instances presented after the link is followed, in satisfying the predefined objectives, as determined from the user's responses.

The modified weighting is determined using the equation:
W=W+R*(dˆn)*b (2)
Where:
   W is the weighting of the link.
   R is the value assigned to the user rating associated with each presentation instance after the link. If the content instances associated with a presentation instance are repeated later (that is, we have already seen it in our backward log analysis), R is made to be a constant negative value set specifically for repeats.
   d is a rate of decay, imposed to apply declining importance to links as they are separated by more and more pageloads.
   n is the distance between the current link and the one subsequently followed by the user)
   b is a bonus awarded if the user has been referred to the site for the first time. Otherwise it is set to 1.

Thus, in the example set out above, using the values:
User rating “one” −R=10
User rating “two” −R=5
User rating “three” −R=0
User rating “four” −R=−10

The new link weightings are therefore determined as follows:
W(N−1)4B=Wₒ+(−10*(dₒˆnₒ)*b)
W(N−2)3A=Wₒ+(−10*(d₁ˆn₁)*b)+(0*(dₒˆnₒ)*b)
W41A=Wₒ+(−10*(d_{N-1}ˆA n_{N-1})*b)+(0*(d_{N-2})*b)+ . . . +(10*(dₒˆnₒ)*b)
Where:
   Wₒ is the original weighting of the link.
   d_{N-1} is the rate of decay, imposed to apply declining importance to links as they are separated by N−1 pageloads.
   n_{N-1} is the distance between the current link and the N−1th link one subsequently followed.

It will be appreciated that the effect of this is to increase/decrease the weighting of links depending on the user rating given to content instances presented after the links have been followed. Thus, for example, if a content instance is rated highly by the user, the effect of this will be to increase the weighting of the links the user followed to reach the content instance.

Furthermore, the increase in weighting can be controlled depending on the distance between the respective link being modified and the content instance in the network. Thus for example, a link that leads directly to the content instance under consideration is likely to modified by a greater amount than a link further away.

Thus, in the example above, the user rating “four” is applied to the presentation instance (N−1)0. Accordingly, as this is a negative rating, it is likely the weighting of the link (N−2)3A will decrease. Similarly the weighting of the link 41A is also likely to decrease, although as this link is further from the presentation instance (N−1)0 than the link (N−2)3A, the reduction is likely to be smaller in magnitude.

At step 430, a respective rating is assigned to each presentation instance and each associated content instance by the base station 1. For example, if the presentation instance 40 is given a user rating “one” then this is used to modify the presentation instance rating of the presentation instance 40, and the content instance ratings of the two content instances associated therewith.

Generally the ratings of the content instance and presentation instance are based on the user rating, so that in this example, a user rating of “one” will correspond to an increase in the content or presentation instance rating of +10. Similarly, a user rating of “four” corresponds to a content or presentation instance rating of −10. In this example, the ratings “two” and “three” are +5 and 0 respectively.

Thus, for example, in the case of the presentation instance 40, if the user rating is “one”, the presentation instance rating 40 and the content instances C1, C2, have respective ratings of 10.

At step 440 the base station 1 determines if all the pending log entries for all respective users and/or sessions have been completed. If not, then the base station proceeds via steps 450 and 460 to obtain the log entries for the next user and/or session, before repeating steps 410 to 440.

During this process, the modified weightings and content and presentation instance ratings are modified in accordance with each user rating assigned thereto, so that if a number of different user ratings are received for a respective content or presentation instance, then the effect of these ratings is combined. This may simply be achieved by dividing the ratings by the number of times the links were traversed or the content instances presented.

Thus, for example, if a respective presentation instance is rated as “one” by five users, and “two” by three users, then the rating of the presentation instance will be modified by 5×(+10)+3×(+5), giving an overall presentation instance rating of +65/5=13.

Normalisation may also be performed on the responses determined for each user. Thus for example, the user ratings determined for each user maybe normalised so that a user who rates every third piece of content “one” has less influence per rating than someone who rarely finds a piece of content worth “one”. This can be achieved for example, by considering each of the user ratings supplied by a user, and then normalising these so that the average of the user ratings for each user are the same.

Otherwise, the base station 1 goes on to modify the links based on the weightings. In order to achieve this, at step 470, the base station selects a next request option.

The base station 1 then compares the weighting of the next link associated with the selected request option to a predetermined threshold at step 480. If it is determined that the weighting does not exceed threshold at step 490, the link is defined to be on relative probation, at step 500. Otherwise, the link is defined to not be on probation at step 510. Thus, if a link is on probation, it will be appreciated that the link will be retained on probation, unless the threshold is exceeded.

The probation technique is used to allow the relative success of links to be compared to each other, so that less successful links may be identified and removed. In particular, links are defined to be on probation if they are deemed by the processing system to be less successful. If a link is retained on probation for a length of time, this indicates that the link is consistently being judged as unsuccessful, placing the link in danger of being removed. If however, at any stage the link is removed from probation, this indicates that the link is successful in some circumstances allowing the link to be retained.

In the case of relative probation, each of the links for a respective request option are rated against each other, to allow the best performing links to be selected and used in future. In this example, the links are rated against each other by comparing the links to a threshold, although other techniques may also be used.

It will be appreciated that the threshold may be set in any one of a number of manners, depending on the implementation. Thus for example, the threshold may be set arbitrarily so that any links having a lower weighting are put on probation. However, typically, this is used to allow the relative success of the links for a given request option to be assessed over a longer, and thus more reliable, period of time. In this case; the decision to place on probation may be based on the weightings assigned to one or more of the other links associated with the respective request option.

In this example, the respective threshold is selected to be equal to or close to the weighting of the highest weighted link for the respective request option, such that all links having a weighting lower than the best performing link are placed on relative probation.

Thus, for example as shown in FIG. 3, the base station 1 would operate to compare the weighting of the links 61A, 61B and 61C. In this case, if the links have respective ratings of 10, 5 and 2 respectively, the processing system will operate to place/leave the links 61B, 61C on relative probation. Similarly, the link 61A will be removed from/or left off probation.

In any event, at step 520 the base station determines if each link has been considered. If not, the base station 1 operates to compare the weighting of the next link at step 480, as described above. Otherwise, the method proceeds to step 530 at which point the base station 1 determines if each request option has been considered. If not, the base station 1 selects a next request option at step 470.

Otherwise, the base station 1 goes on to compare weighting of the links to an absolute threshold. In order to achieve this, the base station 1 compares the weighting of a next link to the absolute threshold at step 540. If the link is determined to be below the threshold at step 550, then the link is defined to be (or is retained) on absolute probation, at step 560. If the link is above the threshold at step 550, then the link is defined to not be on probation at step 570.

Again, it will be appreciated that probation need not be used, and that links could instead be retained or rejected on the basis of the comparison. However, in general, this does not allow an assessment of the link to be made over as long a period of time, which can result in good links that are generally successful being removed. A more complicated system of link judging over time may also be used, where for example, very poor recent performances lead to deletion quicker than moderately poor ones and/or other considerations are applied to the link.

The technique being discussed currently operates to compare the weighting of each link to an absolute threshold. This allows the relative success of each of the links with respect to each other to be judged. In this case, the absolute threshold may be set arbitrarily, or in accordance with the weighting of all links, or some of the links. Thus, for example, the threshold may be based on the sum of the weightings of each of the links to allow for example the lower 5% weighted links to be defined as being an absolute probation.

In any event, it is determined at step 580 whether each link has been considered. If not, the base station 1 compares the next link to the absolute threshold at step 540.

Once all links have been considered, the base station 1 deletes a predetermined number of probation links at step 590. The number of links deleted can be selected to allow the rate at which the content network is changed to be controlled. Accordingly, it will be appreciated that any number of links may be deleted. However, in this example, 1% of links that have been defined as probation links for the longest period of time are deleted.

In order to achieve this, the base station 1 will maintain a record each time the content network is updated of which links are defined as rather relative or absolute probation links. The base station 1 will then determined which of these links has remained as an absolute or relative probation link for the longest period of time (i.e. for the most successive revisions of the content network). Once this has been determined, the 1% of links are removed.

Accordingly, this allows the base station to periodically determine which links are consistently performing badly, allowing these links to be removed. By removing a larger number of links, this will cause more radical changes to the content network. Whilst this can help large changes to be implemented swiftly, this will generally provide less time for links to be assessed before they are rejected, and accordingly, this may only allow the network to be optimised to a point. Accordingly, the number of links that are removed can be controlled to allow the rate and degree of optimisation provided to be controlled.

It will be appreciated that, for the purpose of alternative systems, this is also the case for controlling the number of content instances that are added to the content network, the number of presentation instances that are created, and the number of times a content instance is repeated within different presentation instances within the content network.

The links are defined in terms absolute and relative probation, as this allows the links to be identified and removed as follows:
Absolutely—identifies links that are performing the worst out of the entire pool of links on the site.
Relatively—identifies links that links are performing badly relative to other link(s) on the presentation instance that have been grouped together for that user behaviour (e.g. selecting one option, or choosing “next” within a certain time period). Relative comparisons are useful because where there are multiple links on a choice, the random distribution of users to each link allows for an empirical scientific determination of the superior link.

Once the links have been removed, it is then necessary to update the content network to include new links, to replace those that are lost, as well as to include new presentation instances and remove unused presentation instances.

It will be appreciated that any presentation instances that do not have any links pointing to them as their destination may be deleted now, before the new links are created. Alternatively, the new links may be created first, although it may be undesirable to allow the new links to be created to these presentation instances that have had links removed as this is an indication that these presentation instances are not performing well.

In one example, the links are generally created on a regular basis in areas of the content network where:

Existing links are performing badly
There is a lot of traffic
There are no links

In order to achieve this, the base station 1 compares the request options and the links to one or more predetermined criteria at step 600, so as to determine a link pool, which is a list of new links to be created, at step 610. Comparing the request options and links to the criteria allows the request options and links to be assessed to determine their ability to meet the predefined objectives that the content network is designed to satisfy. It will be appreciated from this that any number of criteria may be used.

Typically, the base station will select the new links that need to be created based on:
Presentation instances which no longer have links extending from them (ie. Presentation instances that are no longer the source of any links).
The top x % of request options which do not have links.
The top y % most unimproved links given by Wp/W where W is the current weighting and Wp is the previous weighting
The top z % response options losing the most traffic given by W/nˆr where W is the current weighting, n is the amount of traffic received and r is a fraction which reduces the impact of the of n.

In the current example, x, y and z are all set at 0.5%.

At step 620, the base station 1 compares the content instances to one or more predetermined criteria. Again, this is performed to allow the base station to determine a content instance pool of content instances, which are to act as destination content instances for the new links to be created, at step 630. In this example, the request options from which the links are provided will now be referred to as source request options, with the content instances to which the links extend being destination content instances. Thus in the case of the link 41A in FIG. 3, the request option 41 is the source request option with the content instances C5, C6 being the destination content instances.

In general content instances satisfying one of the following criteria are selected:
Content instances which are yet to be tried out in the system
Content instances which are getting relatively good subjective ratings in their own right
Content instances whose links are getting relatively good weightings
Content instances which match the known categories of the content instance on the referring presentation instance
Content instances that got good subjective ratings by users who viewed the exhibited the behaviour for which this link will be slotted for.
Content instances that got good weightings from users who viewed the exhibited the behaviour for which this link will be slotted for.

This may be achieved in any one of a number of ways. However, in this example, the base station 1 selects:
The top 1% of content instances with the fewest associated presentation instances
The top 1% highest rated content instances
The top 1% of content instances having the most improved ratings
A combination of the above three according to the following formula:
   (Wˆ2)/(n+1)/p (3)
   where
      W is the current weighting,
      n is the number of presentation instances and
      p is the weighting given on the previous run.

Once the content instance pool has been created, it is necessary to consider combinations of links and content instances, to allow the most suitable content instances to acts as destination content instances for each link. In particular, this is performed to attempt to satisfy the following aims:
Users who select the respective request option will give the content instance high subjective ratings; but
Is not likely that the user has (at least recently) viewed the content

These aims might sound contradictory but, consider that:
Half of the time, the content instance occurred after the presentation instance and this new path may lead to the user not seeing that the presentation instance(s) that showed the image.
We allow content instances to repeat themselves at a respectable distance.

This is achieved by having the base station 1 examine combinations of link and content instance, contained in the link and content instance pools, to allow the most suited links and content instance combinations to be determined. In one example, it is possible to examine every possible combination. This is achieved by having the base station examine the logs to assess each combination as will now be described.

Thus, the base station 1 selects a new link from the link pool at step 640, and a content instance from the content instance pool at step 650.

At step 660 the base station 1 then operates to determine the proximity of previous occurrences of the respective content instance in the content network. Thus, the base station 1 assesses for the location of the source request option in the content network, the number of links which must be traversed backwards through the content network until another occurrence of the selected content instance is reached.

Thus if a new link is to be created in the content network map of FIG. 3, with a source request option 63 and a content instance C1, the base station would determine that another version of the content instance C1 can be reached via the link 41A.

In particular, if the selected destination content instance occurs before the respective source request option, a close proximity weighting is determined in accordance with the equation:
X=X+1/(P−p)ˆr (4)
Where
   X is a weighting for how closely the pageloads are for this image and presentation instance.
   P is the pageload number of the presentation instance
   p is the pageload number of the image
   r is the rate of decay—a number between 0 and 1 representing the declining importance of content instances repeating as they co-occur further and further apart.

This is done to reduce the chance of users being presented with identical content instances after following only a few links. This is important because users are unlikely, in this example, to want to be presented with the same content instance repeatedly. This may unduly influence further modification of the content network, but also means that the predefined objectives, which in this example include presenting as many content instances as possible, are less likely to be satisfied.

After determining the proximity weighting, the base station 1 operates to determine users' ratings assigned to the content instance by users that have previously selected the respective source request option during the presentation of content instances by the network. The user ratings are determined to allow the base station 1 to judge the success of the respective content instance at satisfying the predetermined objectives of the web site for particular users.

In particular, this is done so that it can be assessed how users that have previously selected the respective source request option have rated the content. The reason for this is that different users having similar tastes will tend to apply similar ratings to the same content instance. Furthermore, as the ratings influence which content instance is presented to the user next, it is likely that users having similar tastes will select the same request option at a given presentation instance.

Accordingly, in this example, the aim is to provide content instances that are rated highly by the users. Thus, using a destination content instance that has previously been rated highly by a user that has selected the respective request option increases the chance of the selected content instance being rated highly by future users of the system.

Thus, if the selected request option presentation instance was selected by a user that has also rated the respective content instance, the base station 1 operates to:
Update an increment of common request options c; and,
Add to a weighting for the content instance in accordance with the equation:
   I=I+i (5)
   Where
      I is the total weighting for people who selected the request option and
      i was the weighting corresponding to the user rating provided by the user for the respective content instance

At step 680 the base station 1 assesses the similarity of the destination content instance and the content instances in the source presentation instance. This is performed to allow at least some similarity between the images, or other content instances, to be provided. Thus it will be appreciated that users will generally prefer to see images which are at least to some extent similar to the previously presented content instances. If widely differently content instances are displayed immediately adjacent to each other, or immediately after each, this is likely to result in the user losing interest in the presented content instances. This in turn may cause the user to leave the web site, which in this example, means the objective of keeping the user interested in the site is unlikely to be satisfied.

In order to determine how closely the selected destination content instance is related to the content instances in the source presentation instance, the content instance are assessed in terms of how many attributes they have in common according to the following fields:
The individual submitter
The category the submitter placed it in
The subcategory the submitter placed it in
The opinion the submitter thought the user would have of it (funny, interesting, etc)
The home country of the submitter
The region of the submitter (Asia, Europe, etc)
The age group of the submitter
What the submitter says the image depicts (eg. a person, an animal, a man-made thing, etc)
The level of education of the submitter

This is achieved by assigning predefined weightings to each type of attribute, to account for the fact that some attributes will be better indicators of similar content than others. Thus, for example, the fact that the same person submitted the image might be 20 times more important than the fact than that the submitter thought users would find it “funny”.

At step 690 the base station 1 determines a weighting for each content instance and link combination in accordance with the proximity, the previous user ratings and the similarity in accordance with the equation set out below:
W=(e*I*t*T)/(c*XˆR*sˆr) (6)
Where:
   I is the total user rating for the respective content instance, for all users that selected the respective request option
   c is the number of times the selected request option and content instance have co-occurred
   t is the weighting for the similarity of the content instance with the content instance of the source presentation instance
   T is a fraction that reduces or increases the effect of the similarity weighting
   X is the close proximity weighting described above
   R is a fraction which reduces or increases the impact of the close proximity weighting
   s is the number of presentation instances the content instance has had created for it so far.
   r is a fraction which reduces the impact of the number of presentation instances

At step 700 the base station 1 determines if each content instance in the pool has been considered for the respective link. If not, the processor returns to step 650 to allow the next content instance to be considered.

If all content instances in the pool have been considered, the base station 1 operates to determine if each link in the pool has been considered at step 710. If not, the base station returns to step 640 to allow the next link to be selected. In this manner, the process is performed until a weighting has been determined for each link and content instance combination.

Following this, at step 720 the base station 1 selects one or more destination content instances for each link in accordance with the determined weightings. Thus, for example, the base station 1 will first determine how many content instances are to form the destination content instances for a particular link. The base station 1 will then select the content instances which in combination with the link have the highest weighting.

Having assigned one or more content instances to each link at step 720 the base station 1 determines a proportion of the new links that are to connect to new presentation instances as opposed to existing presentation instances at step 730. This is performed to ensure that new presentation instances are created to thereby further improve the effect of modifications to the network. It may be set according to how large the content network currently is relative to how large it is allowed to grow.

At step 740 the base station 1 selects a next link to be created from the link pool. The base station 1 then determines if the required number of links to existing presentation instances have been made at step 750. If it is determined that this is not the case at step 760, the base station 1 operates to determine if a suitable presentation instance already exists within the content network at step 770.

In particular, a suitable presentation instance may be a presentation instance that includes the one or more content instances that have been selected as the destination's content instances for the respective link.

If it is determined that a suitable presentation instance exists at step 780 the base station 1 operates to create a new link to the existing presentation instance at step 790. In this case, if a number of suitable presentation instances exist, the base station will randomly select one of the existing presentation instances for use as the destination presentation instance.

Otherwise, if no suitable presentation instance exists, or if the required number of links to existing presentation instances have been made, the base station 1 operates to create a new presentation instance including the respective one or more content instances, at step 800. The base station 1 then operates to create the new link to the new presentation instance at step 810.

It will be appreciated by those skilled in the art that this is achieved by defining a new entry in the presentation instance table, and a new link in the link table, in the database 11.

At step 820, the base station 1 generates additional links from the new presentation instance to other presentation instances in the network. Thus, the base station 1 operates to generate links in which the new presentation instance is the source presentation instance, with existing presentation instances in the content network acting as the destination presentation instances.

The new links are created by randomly selecting links from any of the following:
A “sibling” presentation instance—a destination presentation instance for the same choice as the current one, provided there is one.
A “cousin” presentation instance—a destination presentation instance for a different choice for the same source presentation instance, provided there is one.
A “parent” presentation instance—the links of the source presentation instance, provided there are others.
An “unrelated clone” presentation instance—the links of presentation instance with the same one or more content instances.

In any event, at step 830 the base station 1 operates to determine if all links in the pool have been created. If not the base station 1 returns to step 740 and selects the next link to be created. Otherwise the process ends at step 840.

Additionally, once the process is completed, the base station 1 can delete or archive any presentation instance which have no links pointing to them, before deleting or archiving any content instance which are no longer associated with any presentation instances.

The base station 1 removes these presentation instances and content instances as this indicates it is determined that these content instances are no longer of sufficient interest to be maintained within the content network.

It will be appreciated from the above, that the content network is updated by updating the content network tables in the database, as will be appreciated by those skilled in the art.

Thus, for example, the base station 1 updates the tables stored in the database 11, to include the new links and presentation instances, such that the table contents now reflect the modified content network. In addition to this, the base station 1 can update a front end table (called DisplayLinks), includes the links table combined with redundant information from the presentation instance and content instance tables, to allow the base station 1 to need only look up one table for each pageload.

Responses

As briefly outlined above, the nature of the responses used will vary depending on the implementation of the system.

Generally, the responses represent the behaviour of the user subsequent to being presented with the one or more content instances, as determined by the base station 1. The responses may result in the base station 1 causing more content instances to be presented to the user, in which case, the response includes a request (i.e. a request for further content). Furthermore, the base station may evaluate the response to determine a rating, which is used to indicate how successful the presented content instance is at satisfying the predefined objectives.

In the above example, the user rating corresponds to the rating and also to the request, although it will be appreciated that this is not necessarily the case in other examples.

Thus, in the example described above, the user is asked to provide a user rating for the content instance on a scale of “1” to “4”. However, other forms of responses may be used.

Accordingly, the responses may be no more than the use of hyperlinks to select alternative pages, either within the specific web site, or within an alternative web site. The system may set arbitrary ratings for each of these (for example, to apply a higher rating if they remain within the current web site). Or the system may simply rely on predefined criteria unassociated with the request (such as subsequently purchasing a product), as is discussed elsewhere.

Thus, for example, if the user follows a hyperlink (request option) from a presentation instance to an external web site, and buys a car from the web site as a result of an advert content instance provided on the respective presentation instance, then this may result in the presentation instance, content instance and/or content instance combination being given a high rating. In particular, if the objectives of the system are to encourage user to purchase products, this objective is satisfied and the link used to reach the external web site, and links followed to reach the respective presentation instance will have their weighting increased.

In this case, it is also conceivable that the link also have an indication of the content instance that will be presented. Thus, for example, the link may specify “See this dog riding a surfboard!”. This is in contrast to a system where predefined ratings (good, bad, etc) reveal unknown content each time.

A response may even be defined in terms of a non-response, or lack of a response. Thus for example, in the case of interactive radio, each content instance may correspond to a respective piece of content such as an advert, or a song. In this case, the response will be determined from the effect of playing the song or advert. Thus, for example, if the user turns off the radio, selects an alternative station or selects “next song” during a song, this may indicate that the song is not particularly good at retaining the user's interest.

In this situation, the response of changing radio station therefore results in the respective content instances being given a low rating. If however, the user listens to the entire content instance, then this would signify that the content instance is good at retaining the user's interest, so it would receive a high rating. In this case, the lack of a response by the user during the presentation of the content instance is therefore interpreted as a response in itself by the base station 1. Thus, a user response can be provided in the form of a non-response.

It will be appreciated that the responses can therefore be any response (or non-response) as defined within the base station 1.

A further possibility for responses is for an assessment type of response to be used. This is particularly useful if the content network is used in an educational sense. Thus for example, each response could be an answer to a question provided in a respective content instance. By assessing different manners in which information may be presented, and using the response to determine the types of presentation that more often result in correct answers, allows an educational system to be implemented and improved.

Thus, for example, in an education test, the user may start at a presentation instance 1. If they respond quickly, this indicates they have understood the information easily, so they're sent to presentation instance 2 or presentation instance 5. If they answer slowly, this indicates they have had problems and may require further instruction, in which case they are directed to presentation instance 4 or presentation instance 5.

Furthermore, the users are then tested, and their ability to pass or fail the test is used to update the network, such that links followed that resulted in a pass will retained, whilst those that result in fails will be removed. In this case, it will be appreciated that the response provided by the user may be a combination of the response times and the final test result. Accordingly, it is not necessary that the response provided after the presentation of each content instance is used in modifying the network.

Finally, it will be appreciated that the responses may include implicit or explicit requests, in which case the processing system 10 will respond to the response by providing further content, although this is not essential.

Objectives

As described above, the success of links and presentation instances are assessed on the ability of the links and presentation instances to present content satisfying predetermined objectives. In the above example, the objective is to present the users with content they rate highly (and therefore find appealing in some manner).

Examples of objectives the system may use include
Maximising the length of time spent on the system
Maximising the quality of the content seen, as judged by the users
Maximising the quantity of desirable actions performed by the user (e.g. Buying products, submitting their own content, etc).
Maximising the quantity and quality of people the user refers to the system
Minimising the cost of displaying the content—whether it be bandwidth charges or royalties and content licensing fees.
Maximising the revenue earnt for displaying particular items of content. Here, there may be a blurring of the lines between editorial content and advertising whereby advertisers submit content and pay for it to be shown, but that content is still subject to other criteria listed above (such that the advertising does not overly prevent the satisfaction of other objectives).
Maximising the return rate of users to the system.
Ensuring that particular types of users of users visit particular presentation instances.
That users can afterwards perform a task correctly (e.g. pass a test—in the case of a system existing for educational purposes, or hold desired attitudes—in the case of public interest/community service campaigns, such as knowing not to drink and drive.)
Producing or discovering content instances (or sequences of content instances) that yield certain responses from users, or make them behave in certain ways. (e.g. refining the exact elements of musical pieces on an album before release, finding the right mix of sequences of events in a video clip that people find most funny for the storyboard of a movie, finding the right blend of colours for a flower arrangement, choosing the most purchase-conducive text for an infomercial). This would be particularly useful using evolving content instances described below.
Minimising the chance that a user will see the same piece of content more than once. This can be achieved by either or both of:
   Looking back on the user logs to see if there have been repeats
   Requiring the user to state that he has seen the piece of content before. (e.g. via a “Seen this before” button.)
Maximising the ability of users to learn from the presented content instances. This one doesn't have any concrete way of testing specified, which is critical.
   Modifications

Weightings for each user may be mathematically adjusted according to what point the user was in his session—presentation instances which tend to be viewed early in a session will have different weightings to ones viewed later.

Also, where the responses include subjective judgements, some users will be inclined to choose some options more than others. For example, more sensitive people may be easily offended and rate content instances as being “Offensive” a third of the time, when the ordinary person is only offended once in every twenty or so content instances. Thus the effect of an easily offended person clicking “Offensive” could be less than someone who is rarely offended.

Within a world wide web context, and other insecure environments, it is inevitable that automated agents (that is, client-side software programs) will use the site as well, even when forbidden. Measures would need to be taken to ensure that their activity is excluded from the analysis stage. Further, some people will use the system with more regard for making appropriate responses than others. Measures may be taken to reduce the influence “random surfers”.

The examples described above operate by deleting and creating links and creating new presentation instances in response to poor performance. However, the system could also be effective in an environment where content can be modified by the system to achieve the system objectives.

This could be done in two ways:
Content instances themselves can be judged in a similar way to links as described above. Thus, each presentation instance is associated with multiple variations of content instances or content instance combinations and it is chosen randomly which one will be displayed to which user, as it is done with links. The content instances can again have associated weightings that are used to select which content instances are associated with a respective content instance. These are formed form or may be based on the users' subjective ratings and subsequent user activity, again as done with links.
When new presentation instances are created, the new content is not replicated exactly, but has slight modifications.

The above example also focuses on links between content instances. However, the system can also be adapted to define entry points, allowing the first presentation instance to be selected. These entry points may be static or formed using a different methodology.

Other modifications include:
Where a particular presentation instance is referred to another user. The presentation instance shown to that new entering user may be a standard presentation instance for that piece of content shown to all users who enter wishing to view that presentation instance.
Abstract presentation instances that do not hold specific content instances but placeholders that which dynamically find a content instance. For example “the best performing picture of a dog that the user is yet to see” or “one of the better music clip for a genre which we know the user to like”. Thus the presentation instance includes respective content instance criteria that are used to select the one or more content instances to be associated therewith.
   Links may sometimes point to these and thus they can compete with other links on that presentation instance. They would be particularly effective when the user is giving a large number of negative subjective ratings.
   These placeholders might also invoke decision trees or other intelligent decision making processes that learn to send users to links, based upon known attributes of the user and to achieve the objectives of the system.
   The criteria may be based on the content instance rating or weighting, the nature of the content, or the like.
   A similar effect might be achieved by placing this process in links or content instances, rather than presentation instances. That is, links could decide which destination presentation instance to view, or content instances may decide which content instances to actually display to the user (for more discussion on this, see below).
A list of the “best presentation instances” for a particular category or keyword which the user may request on demand, each of which are links to be deleted and added like any other. That is, effectively the “best presentation instances” are the ones that have the best weightings—meeting the system's objectives.
A link might point to a concluding presentation instance, which ends activity. An example of this might be, in the case of an educational system, where the user is taken to a test. If the main objective of the system is for the user to perform well in the test, the network would naturally change over time to test the user at the best times.

The system does not necessarily require the user to explicitly provide details about himself. These may be inferred based upon the known categories of content types they have viewed and, if available, their subjective judgements thereupon. The demographics of a user (their age, sex, location etc.) may be implied by reference to the kind of person who submitted the content or the kind of person the content was aimed at (e.g. if a user likes a lot of pictures submitted by 25 year old males, he is implied for practical purposes to be a 25 year old male.). These may be all that is required for the abstract presentation instances above to be effective.

As described above, many content instances can combine to make a single presentation instance. This may be achieved by selecting specific content instances to be included in a respective presentation instance. Alternatively, the content instances associated with a respective presentation instance could be defined dynamically in accordance with predetermined criteria or predetermined instructions, such as software code or the like.

Thus, for example, one person could define a template for describing cars (with fields formed from content instances like colour, make, price) with the template being available for use to other people in the system. The template could correspond to a respective content instance or presentation instance within the content network, with the data used to populate the template being formed from other content instances. Accordingly, when the content instance or presentation instance corresponding to the template is reached via a respective link, the processing system will operate to obtain content instances to allow the template to be populated with data. This will be achieved in accordance with fields in the template, which may specify a respective content instance to be included as data either absolutely or relatively. In the former case, the template will refer to a specific content instance, whereas in the later case, the template will refer to a type of content instance, such as “present a content instance showing features x, y, and z”, allowing the processing system to select an appropriate content instance. In either case, the processing system will populate the template with data in the form of appropriate content instances, presenting the populated template including the instances to the user in the normal way.

Another person could suggest a slight modification to the template (for example, adding a “year of manufacture” field). Then the two templates will be treated as competing content instances or presentation instances. This competition could take place in terms of the popularity of the subsequent presentation or content instances created with each template and/or the popularity of the template with submitters of content. Thus, in the end the most popular of the templates will be used in preference to the other. It will be appreciated that this is typically achieved by having the templates compete against each other as described in the example above for content instances.

Alternatively, new content instance types could be submitted which can be applied to the data of other content types (e.g. to give effect to this the user could add a “year of manufacture” field but make it not compulsory). The system could thus test this content instance type against existing content instance types.

In this way a large number of content instances can go to make a single presentation instance where all content instances are tested and refined over time, in the ways described above. Content instances may include:
Subsections of a presentation instance—for example the top navigational area, brand logo.
Templates for subsections of a presentation instance—(e.g. particular formats of link lists)
Functional units that actually interact with the user and cause data to be stored and retrieved (e.g. online voting systems, auction proxy bid resolving systems).
“Suggested links” to other presentation instances within the system.

The content instances may be any form of content, such as pictures, musical pieces, video clips, news articles or particular instances of structured information, the latter for instance might be the particulars of a car. Each piece of content may have predefined categories.

In any event, it is also possible for the content instances to be layered with the presentation instances. Thus, for example, a first parent content instance may be provided in the presentation instance, which the causes the processing system to display further child content instances. These parent/child relationships may be defined by contributors or editors of the content instances. Alternatively, they may be developed in a similar manner to the development of the content network described in the example above.

In any event, this is usually achieved by providing respective instructions, such as in the form of executable code associated with the parent content instance. Accordingly, when the processing system 10 attempts to present the parent content instance, the processing system will determine that executable code is present and operate to execute the code.

The code will typically define the relationships to child content instances. This may be achieved absolutely, by specifying a respective content instance, or relatively, for example, by specifying a type of content instance that is to be displayed as the child.

For example, a kitchen content instance may be presented, which in turn requires the presentation of the following content instance types: a dishwasher, cupboard and kitchen sink. Accordingly, in this case, the processing system 10 selects content instances for each of these types to fill their places.

Content instances might also not display information but execute programming code or read data. It may help select other content instances or form processing interrelationships with other content instances.

Content instances could be implemented as classes within an object oriented framework. Accordingly, content types could be abstract objects inherited by content instances. The actual interrelationships could be specified by the contributor—some contributors being programmers creating and modifying classes and other contributors using functional code written by programmers to submit content in a user friendly manner. In either case, the contributor may have the power to specify what objects may call it and what objects it calls.

This could in turn be qualified by the system where combinations of objects (whether abstract or actually displayed) are rated according to how well they meet the objectives. Thus, just as elsewhere, the performance of the relevant presentation instances would influence how often and by whom they are seen, as well as influence the creation of new, potentially similar presentation instances.

Relationships between content instances might also be achieved with a more free-form system where related content instances are described in metadata or the like.

Each content instance may be fixed and unchanging (such as songs lifted from albums, movies, etc), or the system might have the ability to make modifications to the content instance based upon altering elements. For example, this may be achieved by changing the input formula of a fractal, making an explosion more fiery with special effects, changing the pitch of a music track at a particular point, text modifications to a particular article, evolving programming code using genetic algorithms, etc.

These modifications could be made by the system automatically (e.g. slight variation to a constant in a fractal formula, changing the size or compression method in a movie clip) or in response to user's suggestions (e.g. the user suggests an alternative ending to an article, alternative wording in an advertisement).

Throughout the above discussion, the roles of the content instances, presentation instance and links are well defined. Thus, the links are used to control the presentation of subsequent content instances, with the weightings of the links being used to control which links are created or destroyed. The ratings determined from the responses and applied to the content instances are then used to select which content instances become the destination content instances for new links. However, it will be appreciated that the roles of these elements (i.e. the content instances, presentation instance and links) may be altered, and specifically interchanged.

Thus, for example, the ratings given to the content instances or content instance combinations could be used to select which links are created or destroyed, with the link weightings being used to select which content instances are used as the destination content instances for respective links.

Similarly, the ratings could be applied to presentation instances, to allow evaluations to be made.

Furthermore, the links and/or request options could be used to dynamically select the content instances that are subsequently displayed. Thus, for example, if a specific response option is reached, the processing system 10 can be adapted to determine instructions or criteria associated with the response option indicating which link (if within a request option) or destination presentation instance (if within a link) is to be chosen. This is in contrast to the example detailed above, where the link was chosen randomly from the links associated with the response option.

However, the link may alternatively be selected in accordance with the criteria, to ensure the best content instances are subsequently presented to the user. This may be achieved for example, based in information regarding the user, such as age, sex, height, interests, etc. In this case, the instructions may specify which link should be selected for which set of interests, sex or the like.

Instructions can also be provided in the links or presentation instances themselves, again to control the display of information in accordance with the user. Thus, for example, the presentation instance may be for displaying car ad content instances. In this case, when a specific presentation instance is to be presented, the content instances associated therewith may be selected such that women view a different car to men, or the like.

Further, the criteria might not be hard-and-fast (eg. if “Good” then request option 3), but by weightings or qualitative means (eg. the younger the user is, and the closer his proximity to New York, the more likely he will see request option 3).

It will also be appreciated by persons skilled in the art, that the roles of the presentation instances, links and content instances may be interchanged as far as updating the content network is concerned.

Furthermore, it will be appreciated that if only one content instance is presented to the user at a time, then there is a direct correspondence between the content instances and the presentation instances. In this case, presentation instances may not need to be provided, with the links in the content network simply interconnecting content instances directly.

Accordingly, the above is an example of a system and a method for modifying the manner in which content is provided to a user. The technology decides which content should be shown to the user and in what order in response to the user's ongoing feedback, in order to meet predefined objectives of the system. In particular, the techniques apply to content such as images, text, and multimedia content presented via the internet, interactive radio, interactive television or the like.

The system operates by constructing a network of presentation instances and then displaying the associated content instances to the user, in accordance with the network structure and user inputs. In addition to this, the system also operates to modify the network structure in accordance with inputs from the user, to thereby control which content instances that are presented to the user.

Content Modification

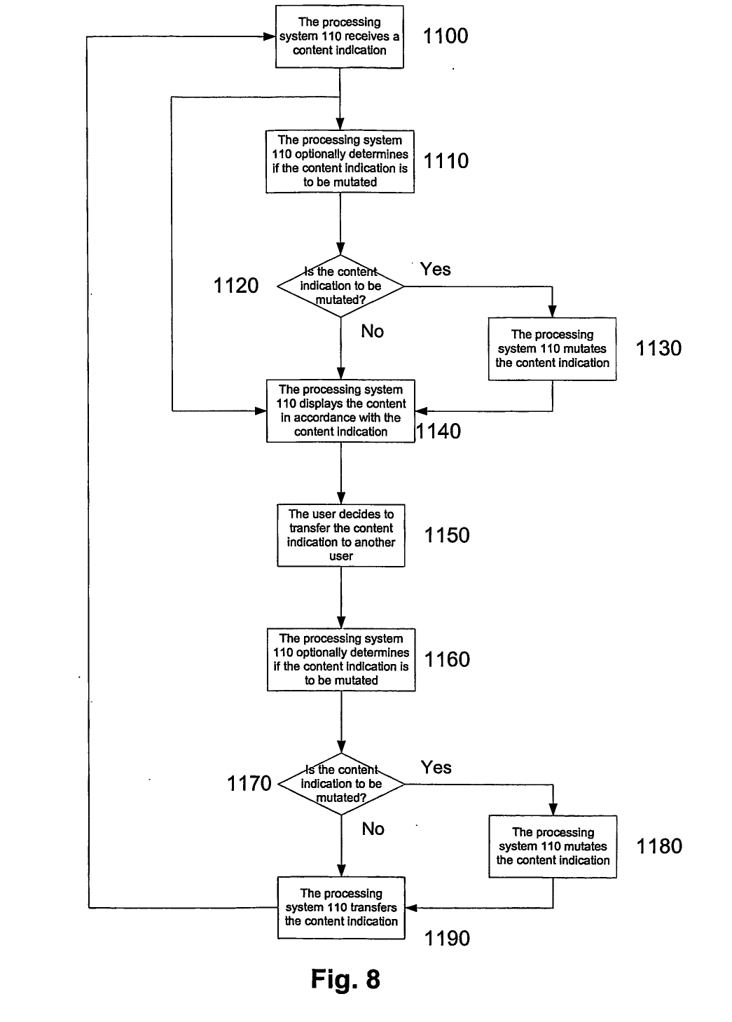

An example of the process of modifying content such as content instances will now be described with reference to FIG. 8. In this example, it will be assumed that the process uses example systems similar to those described above with respect to FIGS. 1, 4, and 5, and these will not therefore be described in any detail.

In particular, at step 1100 the processing system 10 receives a content indication from a user. The content indication represents some form of content to be displayed. Accordingly, it will be appreciated that a number of different forms of content indication may be used.

Thus, for example, the content indication may be the content itself. In this case, the content is distributed in some form which allows it to be displayed by the processing system. This may for example take the form of a file, e-mail, or the like, which contains the content, and which can simply be displayed to the user.

Alternatively, the content indication can be a content specification which represents a trigger that will cause the processing system to obtain and display the content. This could be in any one of a number of forms such as a URL (Universal Resource Locator), an e-mail, MMS message or the like, depending on the respective implementation. It will therefore be appreciated that the content specification may be input manually using the I/O device 22, or may alternatively be received via the external interface.

The process will then proceed either to step 1110, or omit steps 1110 to 1130 and proceed directly to step 1140 (as shown by dotted line), depending on the implementation. In practice, the system may use both options.

If steps 1110 to 1130 are performed, the processing system 10 determines if the content indication is to be mutated at step 1110. In general, the content indication controls the content that is to be presented to the user, and accordingly, modification of the content that is presented can be achieved by appropriate modification of the content indication. In this regard the term “mutation” therefore refers generally to any modification that will result in a change in the content being presented or the way it is presented (eg. using different technical means), which is usually achieved by modification of the content indication.

The assessment of whether mutation is to occur is performed as it may not be desirable to mutate the content indication each time the content indication is used to display content as will be described in more detail below. The assessment may be performed in a number of ways, such as by having the processing system 10 access predetermined mutation rules defining criteria for controlling the mutation of the content indication. Such mutation rules may therefore take any one of a number of forms depending on the respective implementation, and will be discussed in more detail below. However, generally mutation rules indicate one or more of:
Whether mutation of the content indication is to occur,
When any mutations are to occur; and,
The nature of any mutations.

At step 1120 the processing system 10 therefore determines if the content indication is to be mutated, and if so, proceeds to mutate the content indication at step 1130. This may again be achieved using a variety of techniques. However, generally it is achieved in accordance with predetermined mutation rules which specify how the content indication is to be modified to allow different content to be presented. It will be appreciated that the manner in which this is achieved will depend on the respective implementation and will be described in more detail below.

Following this, or if the content indication is not mutated, at step 1140 the processing system 10 displays the content in accordance with the content indication. Accordingly, when the content is displayed to the user at step 1140, the content will either be in its original form if no mutation occurred at step 1120, or if steps 1110 and 1120 were not performed, whilst it will be in a modified form if the processing system 10 has mutated the content indication at step 1130.

In some implementations, a modification may happen every time the content is displayed. That is, there is no decision about whether to mutate, because it always does so. Alternatively, content may be modified only periodically.

In either case, the user can decide to transfer the content specification to another user at step 1150. It will be appreciated that this will only occur in the event that the user has found the content to be of interest for some reason, and this therefore controls whether the content is distributed to other users. If the user does not pass the content on then the process will simply end at this point, although this fact may still be of interest to the log analysis component, which will be described in more detail below.

In the example above, the processing system 10 performs steps 1110 to 1130 to determine if the content indication is to be mutated. However, it may be preferable to mutate the content indication after the content is viewed by the user at step 1110. Accordingly, instead of performing the steps 1110 to 1130, the processing system 10 can perform steps 1160 to 1180, in which the assessment of whether the content indication is to be mutated occurs after step 1150, such that it is only if the content indication is to be distributed that it is mutated. In this case, the processing system 10 will similarly assess whether a mutation is to occur at step 1170, and then in response to a positive determination, perform a mutation at step 1180.

In either case, the content indication may then be transferred to another user at step 1190. This may be achieved in any one of a number of means depending on the implementation, such as by transferring the content specification to other processing systems via the external interface 23, or manually, by having the user communication directly with another user, as will be described in more detail below.

This allows this process to be repeated by other users. Thus, it will be appreciated that if the mutation makes the content more appealing or of interest, then there is a higher chance of any one user transferring the content indication to other users.

As a result, positive mutations which make the information more appealing are more likely to be disseminated, whereas negative mutations which make the content less appealing will tend not to be passed on to the same degree, such that the relative appeal of the content to the user acts as a filter to control the propagation of the mutated content. Similarly, the original non-mutated content may also be transferred.

This leads to the situation in which different versions of the content specification will compete against each in order to be propagated between users, which in turn will continually result in the failure of unappealing content to be propagated. From this it will be seen that as the content propagates and is mutated over time, this will lead to an overall improvement in the appeal of the content for the audiences which pass it on, as will be described in more detail below.

It will be appreciated from the above that the mutation may occur at any time, such as at steps 1110 to 1130, before the content is viewed by the user, or at steps 1160 to 1180 before the content is transferred to another user. The only requirement is therefore that there is an opportunity for mutation to occur between the content being viewed by different users. A further possibility is therefore for the mutation to occur after the content indication is transferred from the processing system 10 at step 1190, but before it is received at another processing system at step 1100, although this is not shown in FIG. 2 for clarity purposes.

The content may be of any one of a number of forms depending on the implementation of the invention. Thus for example, the content can include text, graphical images, audio and multimedia data, such as video sequences or the like. Accordingly, the form of the content indication and the manner in which this causes the content to be displayed and is mutated will depend on the circumstances in which the invention is used.

Similarly the manner in which the processing system 10 assesses whether to mutate the content indication will vary depending on the implementation of the invention, and a number of examples will be discussed in more detail below.

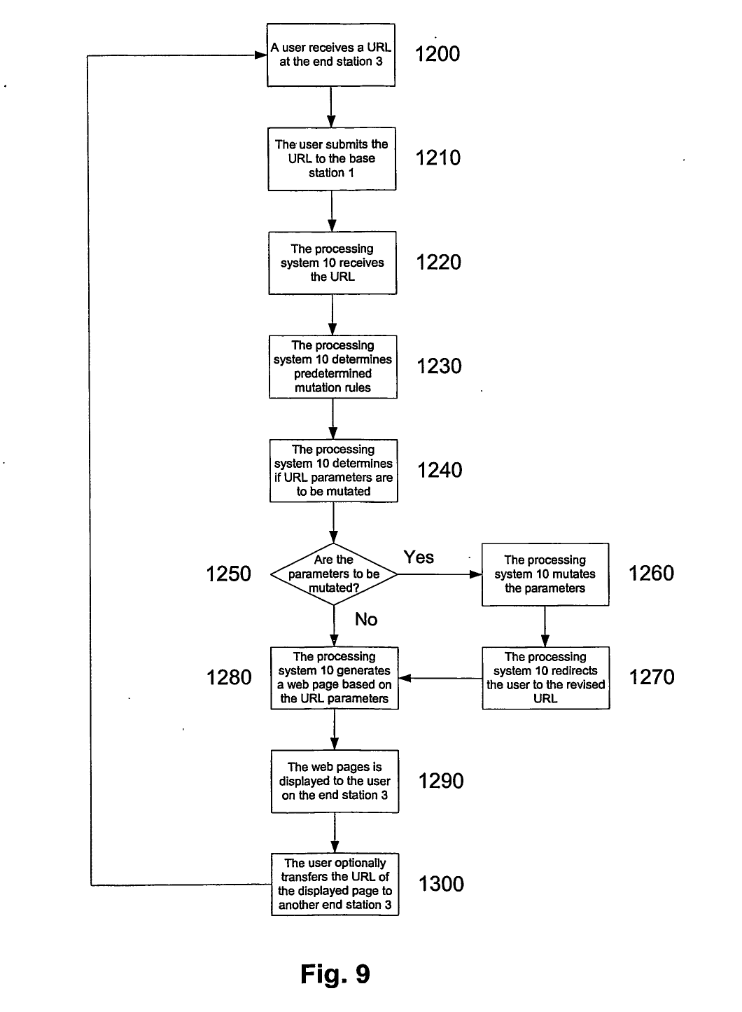

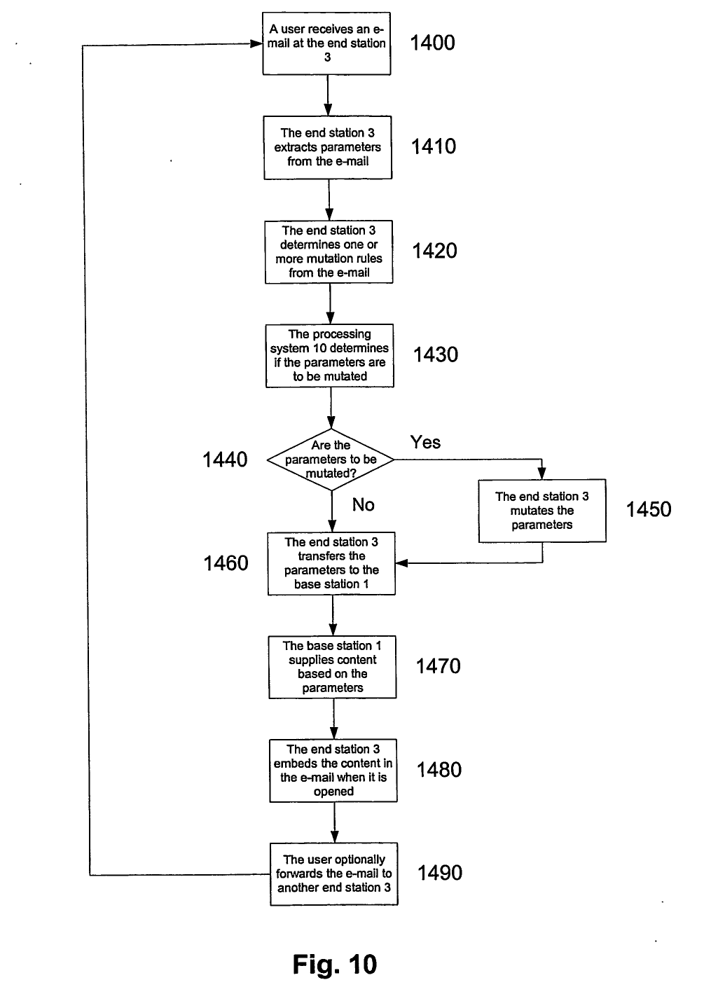

An example of operation of the system to present content to the user will now be described with reference to FIG. 9. In particular, in this example the content indication is a content specification in the form of a URL, with the content being presented as a web page.

Accordingly, a user of one of the end stations 3 receives a URL at step 1200. This may be achieved in any one of a number of manners, such as by receiving the URL embedded in an e-mail, or via instant messaging, or even via alternative systems, such as direct communication between users using for example telephones, letters, or the like.

The user requests the URL from the base station 1 using the end station 3 at step 1210, which is usually achieved by providing the URL in the address window on a web browser as will be appreciated by a person skilled in the art. In this example, the URL is determined by the processing system 10 at step 1220.

In normal circumstances, a web server would then use the URL not only to locate the sites where content is served from, but also to specify any individual code to be executed and the input parameters required for that executable code. Thus, the URL may include parameters, identifiers, scripts, or the like, that are used by a web server to control the web page that is displayed. In addition to this, redirects can be used to automatically transfer users to pages with different URL's which may contain different content in order to achieve mutation that will be sent on in the modified form to others.

In this example however, the processing system 10 operates to determine predetermined mutations rules at step 1230, which define if any mutation is to be performed. The mutation rules are generally stored in the database 11, although this is not essential. In any event, the mutation rules are used to control the modification of the URL depending on certain criteria, as will be described in more detail below. Thus for example, the mutation rules may specify that the URL is to be mutated randomly in which case on certain occasions the processing system 10 will determine if the URL is to be mutated.

In this example, the URL is implemented in the form of a script having a number of parameters. The parameters are executed by the base station 1 to cause the base station to present predetermined content. The manner in which this is achieved will depend on the exact nature of the content. However, it is not essential for the content specification to be a URL, and other forms of the specification may be used.

When parameters are provided in the content specification these can be used to modify the content displayed in a number of ways including:
(a) The parameters form a list of identifiers, which cause the delivery of particular items of content (or content instances). For example, the querystring “title=12&pic=23&pic=240&pic=1” could lead to the display of a title with text matching ID 12 pictures with identifiers 23, 240 and 1, in that order. In this case the database 11 would include a record of the ID's allowing these to be matched to the content.
(b) The parameters affect the appearance of, or the way content is delivered. For example “color=FFEEFF&refresh=10&content_type=gif&nose=large&mouth=small” could lead to the display of a computer-drawn man with a large nose and small mouth in GIF format on an off-white background, refreshing every 10 seconds.
(c) The parameters represent a special identifier which points to a more complex collection of data or parameters, stored in the database 11. It might take the form of a collection of identifiers and parameters as in (a) and (b), or the actual content itself (such as natural language text or a picture). The identifier may be generated specifically for the purpose of displaying the particular page. Descendent “children” of the page (i.e. subsequent mutations) may be assigned a new identifier. The benefit of this is that it allows more genetic complexity than can be stored as parameters in a URL.

Alternatively, parameters may not be required, for example if an arbitrary set of content is simply shown to the user. In this case, the content may be contained within the medium (eg text within an email message, text within the URL which is then displayed on the web page), rather than retrieved from any database, as will be described in more detail below.

For the purposes of this example, it will be assumed that the content is a number of content instances each in form of graphical images, multimedia objects, or the like. In this instance the web page will be in the form of a template with the URL including a script and/or parameters representing the respective content instances which are to be displayed.

Typically the base station will therefore maintain a database 11 of a significant number of content instances with respective ones of the content instances being selected in accordance with the parameters. Thus, for example, the base station 1 may store a database of 500 potentially amusing images. The URL will then specify ten parameters corresponding to respective content instance or image identifiers, which therefore cause ten different respective images to be imported into the template and displayed.

It will be appreciated that the template is not required as every single bit of HTML code could map to an identifier, or there could be preset content including a number of images therein.

At step 1240 the processing system 10 determines if the URL parameters are to be mutated, and if this is determined to be the case at step 1250, the process proceeds to step 1260 with the processing system 10 modifying the parameters.

The manner in which the mutation can be performed will vary depending on the implementation of the invention. In this example, in which content specification includes the parameters outlined in points (a) to (c) above may be mutated in accordance with any combination of one or more of the following respective techniques:
(a) A different set of identifiers are specified. They may be inserted (“title=12&pic=23&pic=240&pic=3&pic=1”), replaced (“title=12&pic=23&pic=499&pic=1”), or deleted (“title=12&pic=240&pic=1”) or a combination thereof.
(b) The parameters are altered. The extent of numerical parameters may be changed (e.g. “color=EEDDEE&refresh=10&content_type=gif&nose=large&mouth=small” would make the background slightly darker) or an option may be changed “color=FFEEFF&refresh=10&content_type=jpeg&nose=large&mouth=small” would now display the man in JPEG format.
(c) The content is changed in some way, (e.g. words are inserted, an animated explosion is made to look more fiery) and a new identifier is created which maps to this new information, with the parameters being updated to reflect the new identifier.

Alternatively if parameters were not used, the content itself could be read and edited. The server may read the actual information which the sender wishes to pass on and the system will alter slightly. (One practical implementation of this would be where a user reads an email, and then activates an HTML form to pass the information on to a friend. The form sends back the text presented to the user (i.e. in HTML syntax the BODY of the message is repeated in HIDDEN input fields). The server then makes textual changes.

In any event, in this example, the processing system 10 mutates the parameters, by modifying one or more of the parameters, such that the modified parameters correspond to ten images, at least one of which is different to those specified by the original unmodified URL. The processing system 10 then redirects the user to the revised URL at step 1270.

The processing system 10 then generates a web page using the mutated URL parameters to access any template and content instances from the database 11 at step 1280. The generated web page can then be displayed to the user at step 1290.

It will be appreciated that if the URL was not mutated, then the web page will include the original ten images thereon. However, if the web-page has been mutated then the web page presented on the end station 3 will have a different set of ten images, such different content is provided to the user.

Following this the user will optionally transfer the URL of the display page to another end station 3 at step 1300. This then allows other users to follow the same procedure.

Thus, in this example, the base station 1 periodically mutates the URL so that one or more of the images presented to a user will be changed. It will be appreciated that if the resulting combination of images is, for example, a particularly amusing combination of images then this will result in the respective URL being transferred to a vast number of people thereby causing wide propagation of the respective URL. This in turn causes wide propagation of the particular combination of pictures.

Thus, if the mutation results in a more favourable page being displayed then this is more likely to be passed on to one or more subsequent users. In fact it is typical for popular pages to be passed on from one user to many other users thereby causing a rapid propagation of the respective content. By contrast, less popular content will tend to be propagated fewer times and indeed may even not be propagated at all such that if a particular mutation generated by the base station 1 results in undesirable information content being displayed then this will then not be passed on to other users.

In this example, the mutation is described as being before the content is displayed to the user requesting the URL. However, as outlined above, a number of variations on this technique are possible.

For example, the mutation could be performed after the user has viewed the content, but before the URL is passed on to another user. Thus, in this case, when a user receives a URL and requests that this is displayed, the URL will always cause content to be displayed in accordance with the received URL. However, once the content is displayed and the user decides to forward the URL, the URL could be mutated, such that the next user will view different content.

This will be achieved in a number of ways depending on the implementation. Thus, for example, the URL may be forwarded using an HTML form at the bottom of the content containing web page is presented to the user. In this example, the user can then enter contact details, such as e-mail addresses of potential recipients of the URL in appropriate fields in the form. Once the form has been completed the base station 1 will use the e-mail addresses to distribute the URL to the other users, with the base station 1 making an assessment as to whether the URL should be mutated at this time. This would typically be achieved in a manner similar to that described above with respect to steps 1240 to 1260, with the base station 1 being adapted to forward the mutated URL if mutation is performed in accordance with the mutation rules.

This allows the mutation to be performed only in the event that the content indication is being distributed to other users (ie after an assessment has been made that the content presented is desirable in some way), as well as ensuring that the mutation is performed, and that the URL is not passed between users in a non-mutated form.

Alternatively, a URL to a document may exist within another web page, and this URL may mutate over time, favouring content specifications that have yielded the most pageviews in the web server logs.

In the above example, content in the form of content instances, associated templates and mutation rules are stored in the database 11, and applied by the base station 1. However this is not essential.

For example, the mutation rules, parameters and/or the content may be embedded in the content specification, which is in the form of a data object. An example of this will now be described with reference to FIG. 6, in which the content specification is implemented as an e-mail, which includes a number of parameters included therein.

In this case, a user receives an e-mail at the end station 3 at step 1400. At step 1410 the end station 3 extracts the parameters from the e-mail together with one or more mutation rules at step 1420. The end station 3 will then determine if the parameters are to be modified in accordance with the mutation rules at step 1430. Thus for example, the mutation rules may indicate that the e-mail is to be modified if it has a certain number of previous source addresses in the e-mail transfer chain Alternatively, the mutation may be timed, performed in accordance with a probability, or the like, as will be discussed in more detail below.

If it is determined at step 1440 that the parameters are to be mutated the end station mutates the parameters at step 1450. Following this, or otherwise, the end station 3 transfers the parameters to the base station 1 at step 1460.

The base station 1 then supplies content based on the parameters. Thus, this may be achieved in a manner similar to that described above by selecting respective content instances from a number of content instances stored in the database 11 in accordance with the parameters. Other techniques may also be used.

In any event, at step 1480 the end station 3 embeds the content in the e-mail when it is opened so that this may then be viewed by the user. Thus, when the user opens the e-mail, they will be presented with respective content based on the respective parameters. If the parameters are mutated the e-mail content will therefore differ to that seen by the sender of the e-mail, whereas if the parameters are not mutated the content of the e-mail will be identical.

In any event, at step 1490 the user optionally forwards the e-mail to another end station 3 in the usual way.

Thus, it will be appreciated that in this example by embedding the mutation rules in the content specification, which in this case is in the form of an e-mail, this allows the end station 3 receiving the content specification to determine the mutation itself.

In this example the parameters are then used to download content from the base station 1. However, it will be appreciated that the content may be downloaded for example from the database 11A or may alternatively be forwarded within the content specification.

Thus for example the e-mail may include twenty picture attachments with five of these being selected for display in the respective e-mail, in accordance with the parameters. This can be achieved by embedding the attachments within the e-mail so that these are not viewed by the user such that the user is only aware of the five respective content instances being displayed. In this particular instance, the e-mail will therefore periodically appear to change that is if it is forwarded between a number of different users.

Furthermore, by embedding all the required properties and content within the e-mail itself, this removes the requirement for the base station 1.

Content

As described above, the system requires some form of source content with an associated content modifying mechanism. Examples of the techniques for providing mutable content include:
Selecting content
   This content may be in the form of a set of content fragments, such as content instances, drawn from a database or file system, which match identifiers provided in the content indication, such as the URL. (e.g. pictures, HTIML fragments)
Generating content
   This may be achieved using a piece of executable code which uses input parameters from a content indication to generate a particular piece of content;
Modifying content
   A piece of content may be transferred as the content indication, with the content itself being modified in accordance with predetermined rules.
Blending content
   Content fragments may be integrated as per the content specification.

In order to achieve this, the system can utilise a number of different types of content indications. In particular, the only requirement is that the content indication must provide for some way in which variable content can be presented, with the content indication being modifiable in predefined manners.

Examples of content indications include:
(a) Content specifications such as Universal Resource Locators (URLs) which include parameters for controlling the loading of pages of content. The parameters can be altered causing the user to be redirected to a new URL with the changed parameters, allowing a different page to be presented, as described in more detail above.
(b) Content indications in the form of the content itself which is displayed as part of a data object, such as an email with the content embedded therein. The recipient is presented with the option of passing on the message to others. This causes a request by the server, where the server may mutate the content, then send out the new content instances (e.g. emails) containing the content in the modified form. An example of this would be where an HTML form resides in an email, which contains input boxes for friends' email addresses. Submission of the form invokes the server to mutate the content and email it to the recipient's nominated friends.
(c) Content indications such as executable code is embedded within a data object (e.g. email) to facilitate the mutation of the referral URL contained in the message. This may be achieved with or without contacting a server to assist in the decision of what and how to mutate.

Furthermore, the content displayed can include a number of different formats. Thus, for example, content can include content instances such as:
Images;
Textual information;
Audio information;
Executable code;
Display code;
Data objects;
Links to other content; and,
Multimedia objects.

In this regard, data objects include any data or executable commands such as Enterprise Java Beans, Perl objects, XML documents, etc, which when executed in conjunction with other data or code will result in the display of some information or other content, as will be appreciated by persons skilled in the art.

Thus, it will be appreciated that different content indications and different types of content may be used in any one of a number of combinations.

Content Categories

The system may utilise a number of individual categories of content for use with different content indications. Thus for example, two categories such as a list of Christmas jokes and a list of Knock Knock jokes, may be provided such that when these mutate, Christmas jokes never appear in the Knock Knock joke pages and vice versa. Thus the different categories are mutually exclusive, and in a biological analogy, might be regarded as “species”.

Content Collections

Collections of content may be provided and utilised to allow users to access a range of different content. Thus, for example, the content collection may interact with the user allowing the user to select to view different subsets, content categories, or other combinations of content, or the like.

An example of this is when the presented content is in the form of a number of related web pages. In this case, the content indication in the form of a URL content specification is used to display a first web page which includes an index to allow the user to link to subsequent pages so that these may be viewed. Thus, the initial web page presented to the user would include a number of different URL links, such as hyperlinks, thereon, which cause the user to be directed to other web pages.

It will be appreciated that the content specification can act to define those links that may be presented. Thus, the links can be viewed as respective content instances, which can then be selected in accordance with a content specification. In this case, the respective index presented to the user will vary depending on the mutations to the content specification.

For example, the links may be used to allow different categories of content to be accessed. In this case, the content specification may cause links to a number of categories of jokes, such as “Knock Knock” jokes or Christmas jokes. In this case, following mutation of the content specification links to different categories of jokes could be displayed.

Alternatively or additionally, the content specification may control the content presented once the links are selected. Thus, the content specification may control the parameters used to select the content presented on the linked web page. Thus, if the link is a URL, then the parameters from the content specification can be imported into the URL link, causing different content to be displayed.

Thus, for example, the index page may be a list of joke categories (“Christmas jokes, knock knock jokes, marriage jokes, etc”), with the content specification identifying particular to jokes within each category. Thus, the content specification may effectively define not only which categories are to be provided on the index page, but also which content instances or jokes with each category are to be displayed.

For example, the content specification may indicate:
Category—Christmas Jokes
   Content Instances—“Christmas_joke_id=52&Christmas_joke_id=525&Christmas joke id=12& Christmas_joke_id=41”
Category—Knock Knock Jokes
   Content Instances “knock_knock_joke_id=42&knock_knock_joke_id=424&knock knock joke_id=142”.

Thus, the actual content instances referred to are not displayed on the index page, but are displayed when the link to the appropriate content category has been selected. Thus, the index page would indicate that either Knock Knock jokes or Christmas jokes can be selected via an appropriate link. Assuming the Knock Knock jokes link is selected, jokes having the identifiers 42, 424 and 142 are displayed to the user on an appropriate web page.

Thus, when the index page is created, the jokes indicated in the content specification of the index page are included as parameters in the links on the index page, as follows:
“<a href=http://www.funnyjokes.com/joke.php?Christmas_joke_id=52&Christmas joke id=525 & Christmas_joke_id=12& Christmas joke_id=41> Christmas jokes<a>”; and,
“<a href=http://www.funnyjokes.com/joke.php? knock knock joke id=42&knock knock joke id=424&knock_knock_joke_id=142>Knock knock jokes</a>”

These joke listing pages can be passed on and mutate separately. But the content indication to the index and related pages may be successful at propagation, both because users like to arrive at “sites”, not merely individual pages, and further, from an evolutionary perspective, the index page would select content on the subsequent pages which support their own propagation at the expense of the subsequent pages.

Alternatively the subsequent pages may not be allowed to mutate, or there could be some other, more complex relationship between the two based on statistical analysis of how they support each other.

An alternative approach is to link to pages which have been performing well. This entails that the index page does not mutate when passed on from person to person, but may change the pages it links to by other methods. One embodiment of this would be a list of current top-performing genetic pages.

Mutation Rules

A number of different mutation rules can be used. Examples of these include:
(a) entirely random
(b) random but weighted towards particular identifiers and parameters which have been known to be successful in the past. This may be known through the application of some log analysis method.
(c) random but weighted towards behaviour as specified in the parameters (e.g. “hair=red&eyebrows=red&same_tendency=high” might specify that the hair and eyebrows of a displayed portrait are red and, when mutating, make it probable that hair and eyebrows will be the same colour.
(d) using some combinatorial scheme (akin to sexual reproduction). (for example “color=FFEEFF&refresh=10&content_type=gif&nose=large&mouth=small” might be requested and mixed with a randomly chosen recent referral e.g. “color=FF00FF&refresh=5&content_type=gif&nose=large&mouth=large” and a child is created “color=FF00FF&refresh=10&content_type=gif&nose=large&mouth=small” inheriting characteristics from both parents.
(e) some other mechanism

The nature of the mutation is implemented will also depend on the nature of the content indication. For example, as mentioned above, if the content indication includes parameters, then mutation is achieved by simply mutating the parameters. Thus, in this case, these rules can for example involve changing the parameters on a random basis such that a random number generator or the like is used to select a number and this is then used to control the alteration of parameters. Alternatively predetermined changes to parameters could be made, such as incrementing or decrementing the parameters in accordance with set rules.

However, if the content indication is the content itself, then there are may not be any parameters to alter, in which case the content itself must be modified.

For example, the content indication can be an e-mail including the content to be presented. In this case, the content indication is the content itself, and this can be modified by making predetermined modifications to the content in accordance with predetermined rules. Thus, for example, if the content is text, the content could be modified by changing words in the text in accordance with predetermined dictionary rules. Thus, when mutation is to occur, the processing system 10 will parse the text content and determine words satisfying predetermined criteria, and then alter these for example using language rules. Alternatively, the e-mail may contain a number of images, with different images being selected in accordance with a predetermined algorithm embedded within the code of the e-mail.

It will be appreciated that it is preferable to control the mutation to gain a trade off between alteration of the content presented and maintaining some form of consistency. In particular if each user views substantially different content, then the forwarding of the content specification will not represent the appeal of the respective content being displayed as the content displayed to the receiving user will inevitably be different.

This can be achieved by adjusting either or both of the mutation rate and the mutation degree.

Thus for example the mutation rate can be adjusted so that the content is only mutated occasionally and this may occur for example by having a mutation probability defined which indicates a one-in-ten chance of the content being mutated. Alternatively, or additionally systems can be configured to monitor how frequently respective specifications have been received and control the mutation accordingly. For example, the base station 1 may be adapted to only mutate the content indication after it has been used a predetermined number of times. In order to achieve this, the base station 1 can maintain a log in the database 11, indicating occurrences of respective content specifications being received and subsequently displayed and/or mutated.

More sophisticated implementations would allow the inputs into the decision as to whether and how to mutate to also be subject to mutation, just as they do in the biological world.

Alternatively, the log may form part of the content indication itself. In this case, the log may only reflect the history of distribution and mutation of the respective content indication instance. Thus, when a content indication is transferred to multiple users, a separate log will be provided for each content indication. Whilst these will initially be identical reflecting the fact that both content indication instances have the same history initially, they will become different as each content indication instance is distributed and mutated. In this case, the mutation rules can cause mutation to occur based on the usage of the content indication from the last mutation or the like.

If the log is maintained by a central base station 1, either in the content indications or the database 11, then the log may be updated to reflect total relative distribution and usage of all different mutation versions of the content indication. This allows the mutation rules to base the mutations on additional factors, such as the relative rate of mutation, and/or success of other content indication versions.

Thus, this allows the distribution and modification of content indications to be monitored on a case by case basis.

In any event, using a log to monitor content presentation can ensure that content specifications are not modified to frequently. Alternatively, the operation of the system can be monitored and the mutation rules themselves modified or mutated to allow the operation of the system to be adjusted, thereby allowing an optimum level of mutation to be applied.

Additionally the content specification may include a large number of parameters. The mutation rules can be defined such that only a selected proportion of these may be mutated at any one time to thereby ensure that the mutation degree is also limited. Thus for example if the content specification results in the displaying of ten images it is preferable to ensure that only one or two of these images are altered on any one occasion thereby maintaining consistency between the content displayed between each of the users.

A log providing information regarding the presentation of content in accordance with the different content indications may also be used to assess the success of variations. Thus, in some cases, the URLs or content may be published on web-sites or other media. This may be updated over time according to what variations are successful. (For example, a web page places a link to a particular set of Christmas jokes. Over time, log analysis shows that a different set of Christmas jokes (within the same content group or “species”) is enjoying more page-views among users who are passing them round. The new, more successful link thus automatically replaces the old one).

User Defined Content

It is possible to allow manual mutation of content indications, thereby allowing users to define respective content indications which can be used to present user selected content.

Thus, if the content specification is in the form of a URL with the parameters forming part of a script, the users can be provided with a page that enables them to adjust the parameters to cause different content to be displayed. This will allow users to experiment to find a particularly appealing form of content which can then be forwarded on to other users as described above.

This can be expanded upon by providing the base station with a content generation system which will allow users to access a web page showing all available content instances. The users can then create their preferred combination in a form of manual mutation to help speed up the process of finding the most appealing combination of content. Once a desired combination of content is defined, this can be used to generate an appropriate content indication which can be distributed in the normal way. Alternatively, where parameters take the form of numerical or categorical values, the user may select these using a form.

Also, a user may make modifications to the actual content instance (eg. changes to text). These may be stored in a way where the alternative fragment becomes a mutation option for other views of the content “species”. In the mutation process, these may be mixed with other user modifications. For example, we have a sentence “A priest walks into a bar” and one user suggests it be changed to “A nun walks into a bar” and another suggests “A priest walks into a pub”. The system is then free to try “A nun walks into a pub.”

In any case, monitoring a log of distribution and modification of the content indications will allow the base station 1 and operators thereof to determine the content indications which have been propagated the most and which are therefore the most favourable in targeting further content presentation.

This can allow the system to be used to compare the success of different content indications. Thus, in the case, in which content indications are defined by users, then the base station can compare the distribution of the content indications are thereby assess their success at being propagated. This can then be used by the base station 1 to determine the relative success of different user defined content indications allowing users to be provided with an indication of the success of the respective content indications. This in turn will allow contests to be run to find the most successful user defined content indication.

Users may also be permitted to submit content instances and the nature of the system means that low quality submissions will automatically be seen less. Again, logs can be used to monitor the presentation of user submitted content. Thus, users may be given incentives to submit content by being given a score indicating how successful their contributions have been. In this case, the success of the content could be measured by monitoring how many times it is presented, although this may be weighted by the quality of the users who view the page, as per some criteria. This would also allow contests to be run as to which individual could select the most content.

In this case, once it is determined by analysis of the log that respective content instances are less popular, their likelihood of appearing in a mutation may also be reduced by modifying an associated weighting as outlined above.

General

Accordingly, it will be appreciated that the system described above enables the altering of content in accordance with passive feedback provided by the forwarding or no of content specifications. This is allows the popularity of content to be judged without requiring the user to participate in active feedback by having the user enter ratings representing the appeal of the content, or the like. This is beneficial because most users will not participate in active feedback as there is no inherent benefit to them.

By analogy with the biological world, the content indications are organisms that may be dispersed across an environment in the form of the Internet. Reproduction occurs when the content indications are published or passed on to others, with mutations providing for variations in traits of the organisms, when the user is provided with different content. Natural selection depends upon users deciding whether to pass on the page to others, and this coupled with the mutation allows the system to automatically evolve towards an optimum content configuration.

The system requires very little server load, over and above an ordinary database-driven website as it does not necessitate any kind of active monitoring of system usage. Mutation and content presentation can be controlled through basic scripting, although such measures may improve performance as discussed above. The system can naturally find ways of appealing to users in ways not foreseen by the content creators and is adaptive to time and audience without the need for any overall conscious creative decision or direction. The system provides a mechanism whereby potentially anyone can contribute content without the need for editors to determine whether it would be compelling to users, as this will inevitably be determined by the natural selection. Where users submit content themselves, the system provides a collaborative medium with less need for a dominant elite controlling direction and privileges.

It will be appreciated by a person skilled in the art that there are a significant number of benefits inherent in this mode of operation. In particular, different people will tend to find different combinations of content instances more appealing than others. Thus for example the users in the age range 18-25 may find a different combination of content instances appealing to those in older age ranges such as 40-50. Similarly, people with different tastes will also tend to find different content instances appealing. However this variation in tastes is automatically catered for in the operation of the system.

In particular, people will tend to forward appealing content to individuals with similar tastes. Thus for example if a user A finds a particular web page appealing they will forward the URL to users B and C who would also find the content appealing. In contrast, they may not forward the content to a user E who would find the content in poor taste. However, an alternative content instance combination will be forwarded to the user E as they might find this appealing. Similarly user E will then forward on content to individuals having a similar taste and so on.

As a result of this, not only does natural selection occur, but this will also take into account the surrounding environment, or user tastes. This can result in a number of different species of content instance, each of which tends to approach an optimum for a particular set of environmental conditions or user tastes. Thus, a first content specification may prove the most popular in the 18-25 age range, whilst a different content specification may prove more popular in the 40-50 age range.

In any event, as the system ensures maximum propagation of those particular combinations which are appealing to the users, this in turn results in parallel mutations of content specification becoming popular amongst appropriate groups of individuals.

It will also be appreciated that the techniques described may operate within a range of different architectures. Thus, for example, the techniques can be implemented using the architecture described above, or may be implemented as part of a distributed system where other servers perform differing roles.

In this latter case, the base station 1 may receive content indications from other servers, and return content to those servers, so they can display them to the user. As part of this, the base station 1 would include directions on how to mutate the content indications. For example, a news site may be seeking to change its logo and wishes to experiment with different combinations, such as whether to make it smaller or darker. The news site takes in three parameters—the article identifier, the logo size and the logo brightness, with the logo size and brightness parameters being passed to the base station 1. The base station 1 then renders the logo based on these parameters, including optional mutation. Thus the base station 1 may decide to mutate the content indication, making the logo slightly smaller. These new parameters are passed on to the user by a redirect or some other mechanism already discussed. The article is retrieved from the news site's database as usual, and the elements are brought together and displayed to the user, such that in this case the user will view the smaller logo.

Thus, in this instance, this allows the base station 1 to maintain control over the mutation, even though the content indication is received by a different server which operates to cause the content to be displayed. Thus, in this case, the content indication will instruct the server to obtain the content from an external processing system such as the base station 1, as described.

It will be understood by those skilled in the art that the techniques could therefore function as web services and other distributed systems such as Microsoft's .NET framework. It may be applied to more complicated areas such as business logic and data analysis.

Architectures

As outlined above, the system can be applied to a number of different architectures, and need not be restricted to those outlined above.

Thus, whilst the above defines a web based implementation, the system could be implemented to allow content to be displayed on a single processing system, as shown for example in FIG. 1.

Furthermore, the references to database, processor, bus, and other components are made in an abstract sense, independent of hardware. The system may, of course, be distributed across many computers or like pieces of hardware.

General

The above therefore describes two examples of techniques which can be used to allow content to be presented, with the presented content being incrementally modified. Both techniques can be implemented on common architectures, which in one example allows a base station to be used to determine, or otherwise influence the content being presented to a user via an end station. This may be based on a user's reaction to content, for example, based on user ratings, such as the selection of subsequent content, or on the subsequent dissemination of the content, and may also include additional factors such as the use of a degree of randomness. In both examples, the modification of content may be performed to achieve any one of a number of objectives, such as determining content which is of greater appeal to users. In general this is performed to maximise the likelihood of content being disseminated, or otherwise viewed by users. The analysis of whether content satisfies objectives can be performed in a number of ways, as discussed in the above examples. Thus, for example, this may depend on whether the user forwards the content to other users for viewing, or the user's response after viewing the content. In one example this is determined during normal processes when a user connects to, or interacts with a content presentation site such as a web-page, and does not necessarily require explicit consideration or feedback from the user.

It will be appreciated that although the two examples are described as distinct examples, the high degree of similarity between the two techniques allows the content modification techniques to be used in a common process, or interchangeably.

Thus, in the content presentation example, the system uses evolving links between respective content, in the form of content or presentation instances, whereas in the content modification example, the system mutates the content being presented, typically by using a content specification to control the content being presented.

However, it is possible for the content network to be used with nodes in the network corresponding to content specifications, which thereby allows the content presented at each node in the network to be mutated in accordance with the techniques used in the content modification example, and vice versa. This could be used to generate new links in the content network, such that as a content or presentation instance is mutated, a new node in the network is created based on the mutated content. This will allow the content network to be used to assess the success of the mutations, by assessing users' reactions to the different versions of the mutated content. Alternatively, the mutation may be used to modify content at respective nodes to determine if this results in an improvement in the weighting of the respective link thereto.

In one example, the first content presented to users in the content presentation example could be formed from content which is periodically mutated in accordance with the content modification techniques to thereby maximise the appeal of the content, and hence the chance of it being disseminated. Upon receiving the content, users can select the content, or other indications, to thereby be directed to subsequent nodes in the content network. This maximises the likelihood of users accessing content in accordance with the content network. Thus, for example, an e-mail may be provided which includes links to respective nodes in the content network. The content included in the e-mail can be periodically mutated to thereby maximise dissemination of the e-mail, and hence the chance of users subsequently accessing content within the content network.

As a further example, content within the content network, such as content instances or the presentation instances may be defined by respective parameters which allows the presented content to be modified. In this case, the content can be presented within a template, with the template forming a node within the content network, such that the template is selected in accordance with user ratings, or the like, as described with respect to the content presentation example. The content presented within the template can then be selected through the use of the parameters as described with respect to the content modification example, such that the template effectively defines the content specification.

In one example, the methods for arriving at weightings discussed in the content presentation example may be applied when content is modified in accordance with the content modification example.

It will therefore be appreciated that the two above described examples represent different examples of techniques for allowing content to be varied for presentation to users, which may be achieved in one example through the use of random trial and error approaches to evolve content for presentation.

In the content presentation example, the technique uses the response of users to determine user interest in sequences of content, with user responses to the sequences allowing modification of the content presented in future. In this example, the modification of links between respective content presentations in the network is used to the improve the content presented, so as to increase the likelihood of satisfying desired objectives. Similar approaches of modifying content for presentation to maximise the ability of content to satisfy objective is also performed in the content modification example.

Thus, in both cases, content can be modified in order to achieve certain aims, with the dissemination of the content being one example of a desirable aim.

It will be appreciated however, that these techniques may be interchanged so that in the content presentation example, the nodes compete with one another to be passed on by people, so people may forward content presented at a specific node within the network. Alternatively, in the content modification example, independent content instances can link to each other.

A further example is to develop content using one of the example techniques, and then subject this developed content to the other technique. Thus, for example, the system could use the content modification technique to develop content, which is then placed into the content network as a respective node. Similarly, content developed as a respective node within the content network, could then be subject to modification as discussed in the content modification example. In this fashion content can be periodically modified by each of the techniques, for example by periodically migrating the content between systems implementing the content presentation and content modification techniques respectively.

It will be appreciated that a number of variations on the above described examples are possible.

For example, in the content network may not require iterative modification of the content therein. In the place of modifications may be simply recommendations for changes which could be then made by some other system or by human intervention.

Furthermore, in both the content network and in content indications, there may even be no suggestion of modifications, but instead the analysis that precedes it is presented to another system or human (eg. which sequences of content are satisfying objectives). This is generally achieved by dividing content into individual elements, such as content elements, content instances, etc, and then performing analysis on the success of the elements at satisfying criteria of interest.

The content network methodology may be implemented for existing content (such as a website) by converting, mapping or abstracting the content it to a content network. In a website example this could entail the hyperlinks becoming links and template elements becoming content instances. Runs of analysis and/or modifications could be run periodically on this, guiding the editors or content management system toward an optimum layout of content to achieve the site's objectives.

The examples described above could be implemented with the elements not representing content but other types of information or other things which can be represented as content instances. One example of this would be customer movement between areas of a department store, where places where the customer stops or take products off the shelf could take the place of presentation instances and suggestions of where to go next, or what to place next to each other take the place of links. It will therefore be appreciated that the terms content instance generally covers any form of element.

Another use may be in determining a desirable layout of supplies in a simulated battlefield. The log could track sequences of manoeuvres where units move between points (content presentations) and these points have differing supplies at them (the content instances). At each geoposition units may be given choices and then be recommended to move to the next point as per a link.

The above two examples could adapted for games where players move around or go between areas or options attempting to achieve certain objectives, while the system has its objective as maximising the length of gameplay, or getting friends to join the game.

Preparation instructions for provided at restaurants may be thought of as content specifications. For example, in a large network of fast food restaurants, individual franchisees may request to use recipes for items of neighbouring restaurants. Head office may only provide modified versions of these recipes.

The content modification system may also periodically modify content without requiring that a system, such as the base station host the content itself. For example, a peer to peer program may routinely modify the users' music such that over time, songs no longer closely resemble the original, but evolve along new paths according to their popularity on the network. In such cases, original digital recording formats such as MPTs (where notes and samples are specifically named) would be easy to mutate as content definitions, but this does not preclude more complicated ways of manipulating more popular formats such as MP3 (such as layering tracks upon one another). In the context of a peer-to-peer network it may be desirable to evolve filenames alongside the music itself (such that they are uniquely identifiable) but this is not required, because preferred mixes will crowd out others for that filename anyway.

Persons skilled in the art will appreciate that numerous variations and modifications will become apparent. All such variations and modifications which become apparent to persons skilled in the art, should be considered to fall within the spirit and scope that the invention broadly appearing before described.

1. A method of controlling the presentation of content, the method including, in a processing system:
(a) presenting content to a user in accordance with a content definition, the content definition including a number of parameters used to define the content to be presented; and,
(b) causing the content definition to be modified to thereby selectively modify content to be presented, the content definition being modified by modifying the parameters in accordance with weightings, the weightings being indicative of the ability of content defined by the parameters to meet predetermined objectives.

2. A method according to claim 1, wherein the content definition includes at least one of:
(a) a content network; and,
(b) a content indication.

3. A method according to claim 1, wherein the method includes:
(a) determining if a respective modification results in the respective content being more successful at meeting predefined objectives; and,
(b) increasing the frequency of presentation of the respective content in response to a successful determination.

4. A method according to claim 1, wherein the content definition includes a content network having a number of nodes interconnected via a number of links, the links being used to define the content to be presented, and wherein the method includes modifying the content definition by modifying weightings associated with at least one the links.

5. A method according to claim 1, wherein the method includes presenting content in accordance with input commands from the user, the commands including an indication of the selection of content to be presented.

6. (canceled)

7. A method according to claim 1, wherein the method includes modifying the content definition at least one of:
(a) randomly;
(b) in accordance with user responses; and,
(c) so as to increase the likelihood of the presented content meeting predefined objectives.

8. A method according to claim 1, wherein the method includes iteratively modifying the content presented over time.

9. A system for controlling the presentation of content, the system including a processing system for:
(a) Presenting content to a user in accordance with a content definition, the content definition including a number of parameters used to define the content to be presented; and,
(b) Selectively modifying the content definition to thereby selectively modify content to be presented, the content definition being modified by modifying the parameters in accordance with weightings, the weightings being indicative of the ability of content defined by the parameters to meet predetermined objectives.

10. (canceled)

11. A method of controlling the presentation of content instances using a processing system, the method including causing the processing system to:
(a) present at least one of the content instances to the user in accordance with a content network, the content network including:
(i) a plurality of nodes, each node being associated with at least one of the content instances;
(ii) a plurality of links for interconnecting the plurality of nodes to define sequences of content instances; and,
(b) determine at least one responses provided by the user in response to the presentation of the at least one of the content instances;
(c) evaluate at least one responses in accordance with predetermined criteria to thereby determine the ability of the at least one presented content instances to satisfy predefined objectives; and,
(d) modify the content network in accordance with the results of the evaluation.

12. A method according to claim 11, wherein the predefined objectives include the effectiveness of a content instance sequence at retaining a user's interest, and wherein the method includes at least one of:
(a) repeatedly modifying the content network such that content instances that are determined to be more able to satisfy the predetermined objectives are presented; and,
(b) modifying the content network iteratively to thereby optimise the content network such that the ability of the content network to satisfy the predetermined objectives is improved.

13-14. (canceled)

15. A method according to claim 11, each node including an indication of a presentation instance, each presentation instance being associated with at least one content instances, and each content instance being associated with a number of presentation instances, the content network including a weighting associated with each link, and the method including causing the processing system, to modify the content network by modifying the weightings in accordance with the at least one response.

16-18. (canceled)

19. A method according to claim 17, the method including causing the processing system to present the content instances by:
(a) presenting at least one content instances associated with a respective presentation instance;
(b) selecting a link in accordance with the at least one responses, the link connecting the respective presentation instance to a subsequent presentation instance;
(c) presenting the at least one content instances associated with the subsequent presentation instance; and
(d) repeating steps (b) and (c) as required.

20. (canceled)

21. A method according to claim 19, each presentation instance including at least one request options, each request option having at least one link associated therewith, the method including causing the processing system to:
(a) determine a request from the at least one response:
(b) select a request option corresponding to the request; and,
(c) select at least one link associated with the select request option.

22. A method according to claim 21, the method including causing the processing system to modify weightings of selected links by:
(a) determining at least one responses to the presentation of at least one content instances associated with a respective presentation instance; and
(b) modifying the weighting of each link selected prior to the at least one content instances being presented in accordance with the determined response.

23. A method according to claim 11, the method including causing the processing system to modify the content network by modifying the links, the modifications including at least one of:
(a) removing a respective link;
(b) creating a new link; and
(c) moving a link from one presentation instance to another presentation instance.

24. A method according to claim 23, each link having a weighting and the method including causing the processing system to compare at least one of the weightings to a predetermined threshold and perform the modification in accordance with the results of the comparison.

25. (canceled)

26. A method according to claim 24, the method including causing the processing system to:
(a) create a new link if at least one of:
(i) the weighting of at least one existing link is below a lower threshold;
(ii) the weighting of at least one existing link is above an upper threshold; and
(iii) a rating of at least one content instance is below a lower threshold;
(iv) a rating of at least one presentation instance is below a lower threshold;
(v) a rating of at least one content instance is above an upper threshold; and,
(vi) a rating if at least one presentation instance is above an upper threshold; and,
(b) remove a link if at least one of:
(i) the weighting of the link is below a lower threshold; and,
(ii) a presentation instance to which the link is associated is removed.

27. (canceled)

28. A method according to claim 11, the method including causing the processing system, to update the content network by:
(a) determining at least one new presentation instance in accordance with ratings associated with at least one of:
(i) at least one content instance; and
(ii) at least one presentation instance; and,
(b) creating at least one links associated with each new presentation instance, each link linking each new presentation instance to at least one existing or new presentation instances.

29. (canceled)

30. A method according to claim 19, the method including causing the processing system to:
(a) determine the content instances associated with a respective presentation instance;
(b) select at least one of the content instances in accordance with at least one of:
(i) a content instance rating;
(ii) a content instance weighting;
(iii) a content instance type, each content instance having an associated type determined in accordance with the nature of content contained therein;
(iv) descriptive data pertaining to the content instance's relationship to other content instances;
(v) a content instance criteria; and,
(vi) predetermined instructions associated with at least one of:
(1) the links;
(2) the presentation instances; and
(3) the content instances; and,
(c) present at least one selected content instances.

31-35. (canceled)

36. A method according to claim 11, the method of including causing the processing system to:
(a) evaluate each response in accordance with predetermined criteria;
(b) determine a rating modification in accordance with the results of the evaluation; and,
(c) apply the rating modification to a rating associated with at least one of:
(i) a content instance;
(ii) a presentation instance;
(iii) a link; and
(iv) a content instance combination.

37-38. (canceled)

39. A method according to claim 11, the method including causing the processing system to determines from at least one response, at least one of:
(a) a rating provided in response to the presentation of at least one content instance, the rating being provided by the user;
(b) an indication of the length of time the user spent observing at least one content instance;
(c) an indication of whether the presentation of at least one content instance to the user caused by a predetermined event.

40. (canceled)

41. A method according to claim 11, the processing system being coupled to an end station via a communication network, the method including the processing system to:
(a) transfer at least one content instance to be presented to the end of the station via the communications network, the end station being adapted to present at least one content instance to the user; and
(b) receive at least one response generated by the end station via the communications network.

42-43. (canceled)

44. Apparatus for controlling the presentation of the content instances, the apparatus including a processing system adapted to:
(a) present at least one of the content instances to the user in accordance with a content network, the content network including:
(i) a plurality of nodes, each node being associated with at least one of the content instances;
(ii) a plurality of links for interconnecting the plurality of nodes to define sequences of content instances; and,
(b) determine at least one response provided by the user in response to the presentation of the at least one of the content instances;
(c) evaluate the at least one response in accordance with predetermined criteria to thereby determine the ability of the at least one presented content instance to satisfy predefined objectives; and,
(d) modify the content network in accordance with the results of the evaluation.

45-48. (canceled)

49. A method of controlling the presentation of content to a user using a processing system, the method including causing the processing system to:
(a) receive a content indication representing content to be displayed;
(b) present the content in accordance with the content indication; and,
(c) selectively distribute the content indication to at least one of:
(i) other processing systems; and,
(ii) other users; and,
(d) selectively modify the content indication in accordance with predetermined mutation rules prior to at least one of:
(i) presenting the content; and,
(ii) distributing the content.

50. A method according to claim 49, the content indication being at least one of:
(a) the content, the method including selectively modifying the content indication by modifying the content; and,
(b) a content specification defining the content to be presented, the method including selectively modifying the content indication by modifying the content specification to there by modify the content presented.

51-54. (canceled)

55. A method according to claim 49, the content being a content collection, the content collection including at least one content instances.

56. The content instances including at least one of:
(a) images;
(b) textual information;
(c) audio information;
(d) executable code;
(e) display code;
(f) data objects;
(g) links to other content; and,
(h) multimedia objects.

57. A method according to claim 56, the method including causing the processing system to present the content instances in accordance with a template, the template being determined in accordance with the content indication.

58-59. (canceled)

60. A method according to claim 49, the content being in the form of a web-page, the content indication being a URL, the method including causing the processing system to:
(a) modify the URL; and,
(b) using a re-direct process to present a web-page in accordance with modified URL.

61. A method according to claim 49, the method of modifying the content indication including;
(a) transferring the content indication to the processing system using a form; and
(b) causing the processing system to:
(i) receive the form;
(ii) modify the content indication; and,
(iii) distribute the modified content indication.

62. (canceled)

63. A method according to claim 49, the mutation rules defining at least one of:
(a) whether the content indication is to be modified; and,
(b) the nature of any modification to be performed.

64. A method according to claim 49, the method including causing the processing system to determine the mutation rules from at least one of:
(a) a store coupled to the processing system; and,
(b) the content indication.

65. A method according to claim 49, the mutation rules being used to modify parameters associated with the content indication at least one of:
(a) randomly;
(b) by selecting alternative parameters from a predetermined list;
(c) in accordance with input commands received from a user; and,
(d) by modifying the parameters in accordance with predetermined rules.

66. A method according to claim 49, the method including causing the processing system to:
(a) maintain a log, the log indicating previous presentation of the respective content, the content log being maintained in at least one of:
(i) a store; and
(ii) the content specification; and,
(b) modify the content indication in accordance with the respective log.

67-68. (canceled)

69. A method according to claim 49, the processing system including a base station coupled to at least one of end stations via a communication network, the method including:
(a) causing the end station to;
(i) receive the content indication from another end station; and,
(ii) transfer at least a portion of the content indication;
(b) causing the base station to:
(i) receive the content indication portion from the end station;
(ii) determine the content for presentation in accordance with the content indication portion;
(iii) transfer the selected content to the end station via the communications network; and,
(c) causing the end station to display the selected content.

70-73. (canceled)

74. A method according to claim 49, the method including causing the processing system to:
(a) receive input commands from a user; and,
(b) define a user defined content indication in accordance with input commands, the user defined content indication being adapted to cause content selected by the user to be presented.

75-76. (canceled)

77. A method according to claim 76, the method including causing the processing system to:
(a) Compare distribution of a number of user defined content indications;
(b) assess the relative success of the user defined content indications in accordance with the results of the comparison; and,
(c) Provide an indication of the relative success to at least one of the users.

78. (canceled)

79. A method according to claim 49, the content including web pages, the web pages having at least one links to other web pages, the method including modifying the content by modifying the links based on the number of times each page is viewed.

80-82. (canceled)

83. Apparatus for controlling the presentation of content to a user, the apparatus including a processing system adapted to:
(a) receive a content indication representing content to be displayed;
(b) present the content in accordance with the content indication; and
(c) selectively distributing the content indication to at least one of;
(i) other processing systems; and,
(ii) other users;
(d) selectively modify the content indication in accordance with predetermined mutation rules prior to at least one of:
(i) presenting the content; and,
(ii) distributing the content.

84-91. (canceled)
